(19) United States
(12) Patent Application Publication
(10) Pub. No.: US 2026/0063504 A1
(43) Pub. Date: Mar. 5, 2026

(54) DEVICES, SYSTEMS, AND METHODS FOR PRECISION DATA COLLECTION & SURVEY-GRADE INFRASTRUCTURE ASSESSMENTS VIA A DISPOSABLE, CARBON NEUTRAL, & MINIMALLY INVASIVE ROBOT

(71) Applicant: Edge Al Solutions Inc., Pittsburgh, PA (US)

(72) Inventors: Allan DUBEAU, Pittsburgh, PA (US); Brian BANNON, Pittsburgh, PA (US); Trevor SMOUTER, Pittsburgh, PA (US); Jeff FULLERTON, Pittsburgh, PA (US); Declan KELLY, Pittsburgh, PA (US); Adam SLIFKO, Pittsburgh, PA (US); Brad SALITRIK, Pittsburgh, PA (US); Scott THAYER, Pittsburgh, PA (US); Brandon INGRAM, Pittsburgh, PA (US); Gavin BAI, Pittsburgh, PA (US); Arthur HILLIKER, Pittsburgh, PA (US); Ryan KUBALA, Pittsburgh, PA (US); Volker HEYDEMANN, Pittsburgh, PA (US)

(73) Assignee: Edge AI Solutions Inc., Pittsburgh, PA (US)

(21) Appl. No.: 19/106,742

(22) PCT Filed: Aug. 29, 2023
(86) PCT No.: PCT/US2023/073043

§ 371 Date: Feb. 26, 2025

Related U.S. Application Data
(60) Provisional application No. 63/373,765, filed on Aug. 29, 2022.

(51) Int. Cl. G01M 5/00; G05D 1/244; G05D 1/678; G05D 101/15; G05D 105/80; G05D 107/50; G05D 109/10; G05D 111/50; G05D 111/63; G05D 111/67

(52) U.S. Cl. CPC G01M 5/0025; G05D 1/244; G05D 1/678; G05D 2101/15; G05D 2105/89; G05D 2107/50; G05D 2109/10; G05D 2111/52; G05D 2111/65; G05D 2111/67

(57) ABSTRACT

A robot configured for inspection of a pipe is disclosed herein. The robot can include a housing, a sensing device coupled to the housing, a carbon-neutral power source positioned within the housing, a plurality of wheels rotatably coupled to the housing, and a computing device communicably coupled to the sensing device and the carbon-neutral power source. The computing device can include a processing unit and a memory to store a software stack that, when executed by the processing unit, causes the computing device to: receive a signal from the sensing device, detect a condition of the pipe based on the received signal, generate a situational alert based on the detected condition, and transmit the situational alert to a user of the robot.

### CROSS-REFERENCE TO RELATED APPLICATIONS

The present application is related to U.S. Provisional Patent Application No. 63/373,765, titled A DISPOSABLE, CARBON NEUTRAL, AND MINIMALLY INVASIVE ROBOTICS SYSTEM WITH MEANS FOR PRECISION DATA COLLECTION AND METHODS FOR ENGINEERING AND SURVEY GRADE INFRASTRUCTURE ASSESSMENT, filed Aug. 29, 2022, the disclosure of which is incorporated by reference in its entirety herein.

### SUMMARY

In one aspect, the present disclosure provides a robot configured for inspection of a pipe is disclosed. The robot can include a housing, a sensing device coupled to the housing, a carbon-neutral power source positioned within the housing, a plurality of wheels rotatably coupled to the housing, and a computing device communicably coupled to the sensing device and the carbon-neutral power source. The computing device can include a processing unit and a memory to store a software stack that, when executed by the processing unit, causes the computing device to: receive a signal from the sensing device, detect a condition of the pipe based on the received signal, generate a situational alert based on the detected condition, and transmit the situational alert to a user of the robot.

In another aspect, the present disclosure provides a system for inspecting a pipe. The system can include a tether including a housing and an interior reel of line, a deployment garage including a frame and a carriage, wherein the frame can be selectively coupled to the line of the tether, and a robot configured to be positioned within the carriage of the deployment garage, wherein the robot includes a plurality of wheels, a housing that can be selectively coupled to the line of the tether, a carbon-neutral power source positioned within the housing, a sensing device configured for selective engagement to the housing, and a computing device communicably coupled to the sensing device and the carbon-neutral power source, wherein the computing device includes a processing unit and a memory to store a software stack that, when executed by the processing unit, causes the computing device to receive a signal from the sensing device, detect a condition of the pipe based on the received signal, generate a situational alert based on the detected condition, and transmit the situational alert to an end user of the robot.

In still another aspect, the present disclosure provides a computer-implemented method of inspecting a pipe. The method can include training an artificial intelligence model with training data including information associated with the pipe, receiving, via the processor, a signal from a sensing device of a robot deployed within the pipe, transmitting, via the processor, information associated with the received signal to the artificial intelligence model, generating, via the artificial intelligence model, an output based on the information associated with the received signal, wherein the generated output includes a determined condition of the pipe, generating, via the processor, a situational alert based on the generated output, and transmitting, via the processor, the situational alert to an end user of the robot deployed within the pipe.

### BRIEF DESCRIPTION OF THE DRAWINGS

The novel features of aspects described herein are set forth with particularity in the appended claims. The aspects, however, both as to organization and methods of operation may be better understood by reference to the following description, taken in conjunction with the accompanying drawings.

FIG. 1 illustrates a perspective view of a disposable, carbon-neutral, minimally invasive robot, in accordance with at least one non-limiting aspect of the present disclosure;

FIG. 2 illustrates a side view of the disposable, carbon-neutral, minimally invasive robot of FIG. 1;

FIG. 3 illustrates another perspective view of the disposable, carbon-neutral, minimally invasive robot of FIG. 1;

FIGS. 4A and 4B respectively illustrate a front and back view of the disposable, carbon-neutral, minimally invasive robot of FIG. 1;

FIG. 5 illustrates a perspective view of another disposable, carbon-neutral, minimally invasive robot, in accordance with at least one non-limiting aspect of the present disclosure;

FIG. 6 illustrates a side view of the disposable, carbon-neutral, minimally invasive robot of FIG. 5;

FIG. 7 illustrates a back view of the disposable, carbon-neutral, minimally invasive robot of FIG. 5;

FIG. 8 illustrates a perspective view of another disposable, carbon-neutral, minimally invasive robot, in accordance with at least one non-limiting aspect of the present disclosure;

FIG. 9 illustrates a side view of the disposable, carbon-neutral, minimally invasive robot of FIG. 8;

FIG. 10 illustrates a perspective view of an accessory configured for use with the disposable, carbon-neutral, minimally invasive robot of FIG. 8;

FIGS. 11A and 11B respectively illustrate a perspective and side view of another accessory configured for use with the disposable, carbon-neutral, minimally invasive robots disclosed herein, in accordance with at least one non-limiting aspect of the present disclosure;

FIGS. 12A-C respectively illustrate a perspective, front, and side view of another accessory configured for use with the disposable, carbon-neutral, minimally invasive robots disclosed herein, in accordance with at least one non-limiting aspect of the present disclosure;

FIGS. 13-15 respectively illustrate a perspective, front, side, and top view of another accessory configured for use with the disposable, carbon-neutral, minimally invasive robots disclosed herein, in accordance with at least one non-limiting aspect of the present disclosure;

FIGS. 16-18 respectively illustrate a a perspective, front, and top view of another accessory configured for use with the disposable, carbon-neutral, minimally invasive robots disclosed herein, in accordance with at least one non-limiting aspect of the present disclosure;

FIG. 19 illustrates a block diagram of a hardware architecture configured for use with the disposable, carbon-neutral, minimally invasive robots disclosed herein, in accordance with at least one non-limiting aspect of the present disclosure;

FIG. 20 illustrate a software stack configured for use with the disposable, carbon-neutral, minimally invasive robots disclosed herein, in accordance with at least one non-limiting aspect of the present disclosure; and

FIG. 21 illustrates an improved pipeline inspection system configured to facilitate operation of the disposable, carbon-neutral, minimally invasive robots disclosed herein, in accordance with at least one non-limiting aspect of the present disclosure; and

FIG. 22 illustrates a human-machine interface configured for use with the disposable, carbon-neutral, minimally invasive robots disclosed herein, in accordance with at least one non-limiting aspect of the present disclosure;

FIG. 23 illustrates a logic flow of a method 1200 of generating and transmitting a situational alert via the disposable, carbon-neutral, minimally invasive robots disclosed herein is depicted in accordance with at least one non-limiting aspect of the present disclosure; and

FIG. 24 illustrates a flow diagram of an algorithmic method of detecting the condition of the pipe performed via an artificial intelligence model is depicted in accordance with at least one non-limiting aspect of the present disclosure.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

In the following detailed description reference is made to the accompanying drawings. In the drawings, similar symbols and reference characters typically identify similar components throughout several views, unless context dictates otherwise. The illustrative aspects described in the detailed description, drawings, and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

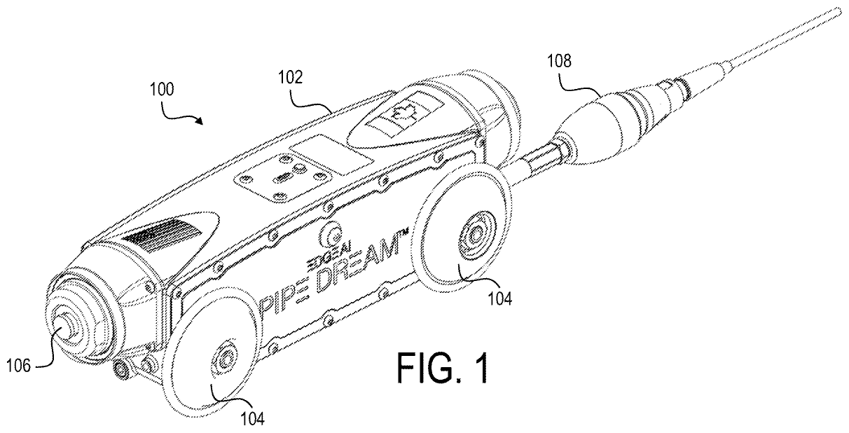

Before explaining the various aspects of the disposable, minimally invasive robots 100, 200, 300 (FIGS. 1, 5, and 8) disclosed herein, it should be noted that the various aspects disclosed herein are not limited in their application or use to the details of construction and arrangement of parts illustrated in the accompanying drawings and description. Rather, the disclosed aspects may be positioned or incorporated in other aspects, embodiments, variations and modifications thereof, and may be practiced or carried out in various ways. Accordingly, aspects of the fall protection apparatus, system and method disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as inward, outward, upward, downward, above, top, below, floor, left, right, side, interior, exterior and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

This invention relates to the inspection of pipelines via remote controlled or autonomous robotic devices; for the purposes of general condition assessment, engineering assessment, including operational and structural analysis, infrastructure survey, and precise geolocation. More specifically, this invention relates to the general condition assessment of potable, storm, and wastewater pipelines in the size range of 6″ to 18″ inches in diameter. The invention can be utilized by the 22,000 small or underserved municipalities and rural water authorities in the United States that cannot afford to own their own inspection equipment and, as a direct result, are forced to pay premium costs for emergency and low volume inspections.

As of 2021, the US wastewater infrastructure consists of over 800,000 miles of public sewers and 500,000 miles of private lateral sewers. Currently these pipelines transport about 61.5 billion gallons wastewater per day. This massive volume of daily raw wastewater is then treated by the 16,000 publicly owned Wastewater Treatment Plants (WWTP) and released back into the environment. 80% of the US population is reliant on that system, while the other 20% use septic tanks.

These 1.3 million miles of public and private sewers in the U.S. are distributed across a range of sizes. Public sewers, which make up approximately 80% of the sanitary sewer pipelines in the U.S., are 8, 10, or 12 inches in diameter. The remaining are large diameter sanitary sewers that range in size from 15 inches to 240 inches or more. Private lateral sewers tend to be in the smaller range (6 to 12 inches) as they connect homes and businesses to public sewers.

The average age of wastewater pipes in the US is 45 years old, with some specific systems having an average life of 100 years or more. As a note, the expected lifespan for wastewater pipes is 50 to 100 years. In 2021, the American Society of Civil Engineers (ASCE) released a report card for America's infrastructure. In this assessment, the ASCE gave the U.S. wastewater infrastructure a grade of D+. The report cites the low condition grade is a direct result of the rising costs of operations and maintenance coupled with the annual water infrastructure spending gap of $81 billion. On a positive note, the more prevalent use of assessment management plans (made possible by efficient and affordable inspection programs) has enabled 62% of survey utilities to proactively manage infrastructure management. It should be noted that the municipalities able to perform proactive asset management are usually the larger and more well-financed municipalities. Smaller, underserved, and rural water systems that lack access to affordable inspection and asset management technology are forced to respond reactively to pipeline and equipment failures.

Robotic inspection of pipelines has been common since the first Closed Circuit Television (CCTV) inspection platform were introduced in the early 1960's. Until relatively recently the technology available for this class of pipe inspection involved small inspection platforms that were connected to a dedicated box truck via bulky electromechanical tethers. The purpose of the box truck is to house the tether reel and operator workstation, as well as the control electronics and human interfaces.

While these systems are relatively effective in the task of pipe inspection and have a 60-year record of use in the pipe inspection market, they do have severe limitations that prevent universal access to state-of-the art condition assessment technologies. The most fundamental limitation is cost. Average prices for these systems range from $125K-350K plus, well beyond the capital budget of nearly all the smaller municipalities and rural water association across the nation. The second limitation is caused by a complexity of use that comes from the dated nature of the technology. These systems require operators with costly custom training to operate the robot, inspection software, as well as standard safety and confined space training. As a result of both the prohibitive cost and complexity of use, these underfunded and overlooked agencies are forced to pay premiums on inspection services. This can be due to various reasons, such as having a small volume of inspection footage or large mobilization-demobilization fees that are, unfortunately, common and required by the industry to support its own financial footprint.

Advances in electronics, advanced communications, robotics, sensing and perception technologies led to advancements over the CCTV inspection platform, and such advancements opened the possibility to perform robotic inspection of pipes without the need for the attached truck, tether, and in some cases the operator. For example, U.S. Patent Application Publication No. 2006/0290779 discloses a small pipe inspection robot which features an autonomous, truck-less inspection system with a self-contained tether. While the robot was a quantum leap forward in wastewater inspection technology and paved the way for a host of fast followers, adaption of the technology was limited. The low take rate for this technology can be traced to the same factors (primarily cost) as standard CCTV inspection equipment that made it prohibitive to small and underserved municipalities. While this new class of robotic mechanism does provide a reduced logistical footprint and includes an array of integrated technology, it remains overly costly, unnecessarily complex, expensive to maintain, and too difficult to operate efficiently for universal adaptation.

To provide access to state-of-the-art condition assessment tools to small and underserved municipalities, an improved pipeline inspection system is needed. Although such technologies should maintain the reduced logistical complexity and advanced technology of the current state of the art, the new inspection technologies should also reduce total cost of ownership, including capital, operational, and maintenance expenses by at least one order of magnitude. Accordingly, there is a need for devices, systems, and methods for precision data collection and survey-grade infrastructure assessments via a disposable, carbon neutral, and minimally invasive robot.

For example, the robots 100, 200, 300 (FIGS. 1, 5, and 8) disclosed herein are optimized for inspection of small diameter pipelines, built for the purposes of precise collection of condition assessment data, and subsequent engineering analysis. The disposable robot can provide underserved municipalities and rural water authorities with the capability to perform an easy to use, carbon neutral, and high-quality condition assessment with low operational risk and minimal operational impact, complete with an affordable inspection.

Small municipalities and rural water authorities don't have access to high quality condition assessment and engineering services largely due to economic and geographical constraints. These organizations cannot afford to own their own inspection equipment and they often don't have personnel with sufficient experience and training to deploy these types of systems. Additionally, these smaller organizations don't have the scale to operate and maintain these systems effectively. These limitations, along with industry wide budget constraints, have created demand for a disruptive new approach to pipeline inspection systems that is reliable, affordable, requires limited maintenance, and can be deployed effectively with minimal training.

To produce an improved pipeline inspection system that meets the unique demands of small and underserved municipalities, a radical change in the design of these systems is called for. The new design should increase the level of technological sophistication but dramatically reduce the cost. These types of changes, that increase technological function but reduce the cost of the technology by orders of magnitude, were not possible until relatively recently. This is due to a convergence of technological advancements that has revolutionized the availability of high-performance computing on the edge, miniaturized sensors, and effectors, and made large advances in the manufacturing of low cost and reliable components at low volume industrial scales of 1,000 and 10,000 units.

Critical technological advancements that are leveraged into the improved pipeline inspection system include: low-cost manufacturing, high-intensity and low-power LED lighting, edge computing, artificial intelligence, computational imaging, and micro-miniature electronics. While individually these advancements are necessary, they are not sufficient unless they are integrated under an agile design process that fuses the individual technologies into functional pipe inspection devices/systems.

The improved pipe inspection robot utilizes four design pillars that serve as guideposts for the engineering effort to produce a pipeline inspection system that is optimal for small or underserved municipalities and rural water authorities. These design pillars are presented as (a) disposability, (b) carbon neutrality, (c) minimally invasive, and (d) collection of engineering grade infrastructure assessment data.

The next few sections describe the linkage between these design principles and various aspects of the improved pipeline inspection system.

Disposability. Disposability is tackled first because it is traditionally associated with either single or limited use products. In other words, products with high disposability are designed with specific intent for a certain period or specific number or duration of uses. When either the expected shelf life of a product has expired or the product has been used to its limit, that product is discarded, must undergo systemic repair, or be replaced. The canonical example of a product with high disposability is the daily contact lens. These lenses are prescribed for single use and then gotten rid of. A second example would be disposable batteries, which last for a certain amount of time. The common link between the designs of all highly disposable products is the deliberate use of a low-cost bill of materials. This is enabled by manufacturing at relevant scales. In the cases of daily contact lenses and batteries, that scale is enormous and driven by yearly consumer volumes measured in millions or billions of unit sales.

In the case of pipeline inspection, manufacturing volumes are much lower, typically in the range of thousands of units. Disposable products require more than manufacturing scale to maintain key performance. They also require a combination of various low-cost materials, sensors, effectors, and computing power, all of which are carefully engineered to reliably provide high performance over the intended life of the product. This more traditional definition of disposability, while necessary, is not sufficient to account for the principal aspects of the improved pipeline inspection system described herein.

Each aspect of the improved pipeline inspection system includes disposability at the bill of materials and manufacturing levels like contact lenses and batteries. However, the concept of disposability featured by the improved pipeline inspection system goes beyond. Again, each aspect of the improved pipeline inspection system is designed to be sacrificial with respect to using a robotic device inside a constricted environment. When framed in this context, disposability means that the device has been purposefully designed to be destroyed by high-pressure sewer jetting equipment. This enables the operator of the equipment to intentionally destroy the device to prevent backups, overflows, or extremely expensive dig and remove operations (device retrieval).

Minimally Invasive. Traditional sewer inspection technologies are invasive on multiple levels. Examples of this multi-scale invasiveness are (a) the size and cost of the standard pipeline inspection equipment, (b) the large and heavy nature of this equipment can disrupt traffic, (c) standard equipment be loud and noisy at inconvenient times, and (d) standard equipment can cause damage to associated infrastructure like roadways, sidewalks, and homeowner driveways, and (e) traditional equipment requires power generation which causes air pollution and has a large carbon footprint. These disruptions are common and happen when the systems are working as intended and used appropriately. Should standard inspection systems become stuck or abandoned within the pipeline, a myriad of new issues will emerge for both the municipal owner and the contractor or municipal employees who are charged with conduction these operations. These new issues include the specter of overflows, EPA fines, sewer backups effecting private homeowners, and inevitable lawsuits.

Each aspect of the improved pipeline inspection system is specifically designed to be minimally invasive in terms of usage impact on the pipeline and on any surrounding private and municipal infrastructure. This minimal invasiveness is derived from comparison to standard industry products offerings that normally rely on large box trucks, heavy equipment reels, and external generators to power the operation. With the improved pipeline inspection system, everything the operator needs to conduct the operation is provided as part of a compact package that is designed specifically to: (a) minimize operational footprint (the entire system can be easily transported by hand and fits easily within a small Pelican case), reduce environmental contamination (including noise contamination), and to eliminate unintended private property damage (this occurs when private property is accessed to provide right of way for inspections).

Carbon Neutrality. Outside of the construction and design, one of the most prominent features of the improved pipeline inspection system is that it is optimized to be minimally invasive. In other words, it does not pollute the environment by consuming fossil fuels, or through the generation of significant waste byproduct (standard inspection equipment generates this through routine cleaning and maintenance). Standard CCTV inspection systems come with attached diesel generators that provide power independent from the vehicle (generally a box truck or sprinter van). In a typical pipeline inspection operation, the engine from both the generator and vehicle are running, doubling the greenhouse emissions. For each aspect of the improved pipeline inspection system, greenhouse emission ends with the delivery of the system to the work site. In addition, no disposable waste streams are created as a byproduct of use. Furthermore, even at the end of the products life, it can simply be exchanged for a new product and the old product can be refurbished and put back into use.

Engineering-Grade Data Collection. Each aspect of the improved pipeline inspection system includes the precision collection of data suitable for engineering and survey-grade assessment as well as general condition assessment. There is a substantial difference between the two types of assessment. Standard data collection platforms provide general condition assessment information for calculating pipeline remaining useful life and planning operational maintenance such as removal or roots, sedimentation, or obvious pipe repairs. For engineering and survey grade assessment operations, specialty equipment is often required. This equipment is more expensive, more complicated, and less reliable than standard equipment, creates more greenhouse emissions, is more invasive, and can be more damaging to the surrounding environment. The aspects described herein include the ability to collect precision assessment data including high quality images, point clouds, a means for obtaining precise position, a means for processing and analysis on the edge—including absolute geolocation and reference to municipal coordinate systems. This is done without requiring any relaxation of design tolerance around minimally invasiveness, carbon neutrality, or disposability. Furthermore, all the external processing is done in a cloud-based platform that doesn't require the proliferation of data collection and processing computers by the end users. All information and reporting products including raw data, standard condition assessment reports, and engineering reports are delivered electronically eliminating the outdated and costly paper reporting schemes that dominate the industry.

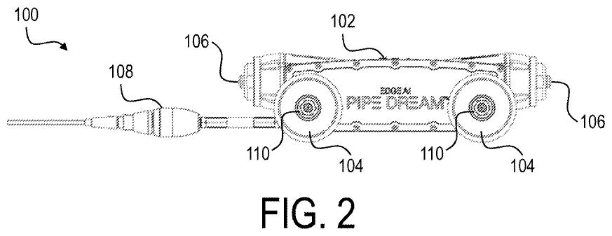

Referring now to FIG. 1, a perspective view of a disposable, carbon-neutral, minimally invasive robot 100 is depicted in accordance with at least one non-limiting aspect of the present disclosure. According to the non-limiting aspect of FIG. 1, the robot 100 can include a machine-block housing 102, one or more wheels 104 as a primary moving device of the robot 100, and one or more sensing devices 106 (e.g., a camera, structured light, microphones, optical sensors, a radio navigation and ranging (“RADAR”) sensor, a sound navigation and ranging (“SONAR”) sensor, a light detection and ranging (“LiDAR”) sensor, an acoustic sensor, an environmental sensor, including temperature sensors, gas sensors, humidity sensors, and the like, multispectral sensors, etc.). Although not explicitly shown in the FIG. 1, the wheels 104 and the at least one sensing device 106 can be modular, such that either can be swapped out using quick and hot swappable connectors. According to some non-limiting aspects, modularity of the wheels 104 can be particularly useful for enhanced mobility, as the wheels 104 can be selected based on a predetermined wheel 104 parameter (e.g., a diameter, a weight, a thickness, a texture, etc.) can be optimally selected for a specific operating environment (e.g., a pipeline). For example, the wheels 104 can include or otherwise be equipped with prefabricated weights, which could provide enhanced mobility through a pipeline by increasing an amount of traction between the wheels 104 and the floor of the pipeline. Such weights will be depicted and described in further detail with reference to FIG. 2.

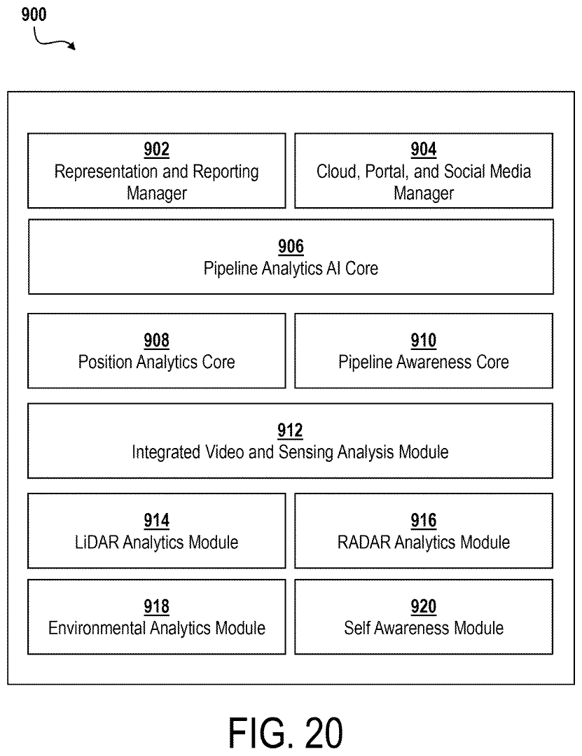

Although, according to the non-limiting aspect of FIG. 1, the depicted robot 100 has four wheels 104, it shall be appreciated that, according to other non-limiting aspects, the robot 100 can include any number of wheels 104 selected in accordance with user preference and/or intended application. For example, alternative aspects of the improved pipeline inspection system can include six wheels 104. Additionally, according to some non-limiting aspects, one or more of the wheels 104 can be tracked with treads and/or a combination of tracked and non-tracked wheels 104 can have specialized inspection applications. Furthermore, according to the non-limiting aspect of FIG. 1, the robot 100 can include a four-wheel 104 housing 102 that is configured to be independently driven, which can provide the robot 100 with full skid steering capabilities. In other words, each motor within the housing 102 can be independently controlled via a separate motor, such that each motor and thus, each wheel can be moved independently, giving the user enhanced control and mobility. However, as will described herein, according to other non-limiting aspects, the robot 100 can be tracked via encoders, IMUs, tethers, and/or other means of determining a position of the robot 100 and thus, the robot 100 itself can track its own mobility via a self-awareness module 920 (FIG. 20) configured to recognize the mobility configuration and optimize control to leverage the capabilities of the prime mover configuration.

Still referring to FIG. 1, modularity of the one or more sensors 106 can be particularly useful for selection of a particular sensor to sense environmental parameters for a particular operating environment and/or intended application. For example, modularity of the sensors 106—via a quick swappable connection (e.g., quick connects, bolts, screws, threaded, crimps, etc.), for example—can support a wide variety of sensors and combinations of sensors including LiDAR, Structured Light, microphones, SONAR, RADAR, and environmental sensor suites. Alternately, modularity of the one or more sensors 106 can be particularly useful for maintenance and repair of the robot 100. For example, if a sensor 106 includes a camera, cracked and broken lenses, the most common form of damage the robot 100 may experience, can be quickly and efficiently changed out in the field. In addition, the aforementioned modularity is not limited to exchange with the same device, as the sensors 106 and robots 100 of FIG. 1 can be interchangeable as components of a system, or kit.

In further reference to FIG. 1, the robot 100 can further include a multiplexed cable 108 configured to transmit signals and/or electrical power to and from the robot 100. For example, the cable 108 can be configured to transmit signals generated by the one or more sensors 106 to a computing device (e.g., a personal computer, a laptop, a tablet, a smart phone, a server, etc.) positioned upstream the robot, which a user of the robot 100 may have access to. Alternately or additionally, the cable 108 can be configured to transmit control signals from the computing device (e.g., a personal computer, a laptop, a tablet, a smart phone, a server, etc.) to the robot 100, such that the computing device can be used to control the robot 100 from a distance. The computing device, for example, can include a display configured to display information associated with signals generated by the one or more sensors 106, thereby providing the user with real-time information generated by the robot 100 as it traverse the operating environment. It shall be appreciated that, according to some non-limiting aspects, the robot 100 can include either an onboard power source (e.g., a lithium ion battery), or can receive electrical power via the cable 108, from a power source positioned upstream the robot 100 while in use. According to the non-limiting aspect wherein the robot 100 includes an onboard power source, it shall be appreciated that the robot 100 of FIG. 1 can be carbon neutral compared to conventional robots, meaning it does not require the cable 108 or any external power source for electrical power. Conventional robots, for example, rely on gasoline-engine powered vehicles or generators for electrical power, which can be expensive and generate an inordinate amount of carbon dioxide when in use. However, the robot 100 of FIG. 1, including the accessories disclosed herein, can be powered on an internal battery, thereby eliminating harmful carbon dioxide emissions and reducing the need to put extensive operational hours on the engine of a vehicle. Thus, the robot 100 of FIG. 1 is more compact and efficient than conventional robots.

Referring now to FIG. 2, a side view of the disposable, carbon-neutral, minimally invasive robot 100 of FIG. 1 is depicted in accordance with at least one non-limiting aspect of the present disclosure. As previously discussed, the wheels 104 can be modular, such that either can be swapped out using quick and hot swappable connectors. For example, the wheels 104 can include or otherwise be equipped with one or more prefabricated weights 110, which can be selectively installed about an axle of one or more wheels 104, thereby increasing the weight of the wheel 104 assembly and thus, increasing an amount of traction between the wheels 104 and the floor of the pipeline. The weights 110, therefore, can provide the robot 100 with enhanced mobility through a pipeline. However, according to some non-limiting aspect, the wheels 104, themselves, can be manufactured to a predetermined weight, thereby eliminating the need for the separate, prefabricated weights 110 of FIG. 2. According to still other non-limiting aspects, the wheels 104 can include other predetermined wheel 104 parameters, including a specific diameter, a thickness, or a texture, amongst other wheel 104 parameters. It shall be appreciated how, by selecting a wheel with an increased thickness, or a texture on an outer surface of the wheel 104, the wheel 104 can increase the amount of friction and/or traction generated, thereby enhancing the mobility of the robot 100.

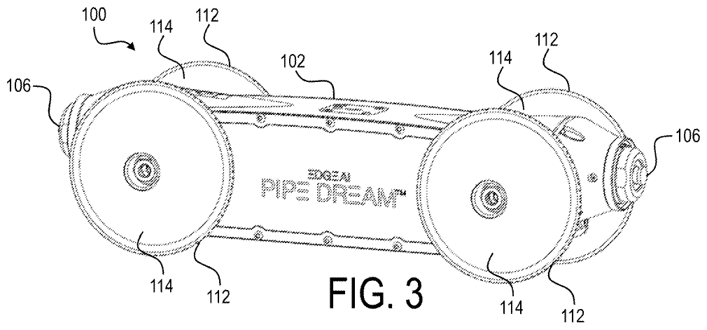

One such textured surface 112 of the one or more wheels 104, for example, is depicted in FIG. 3, which illustrates another perspective view of the disposable, carbon-neutral, minimally invasive robot of FIG. 1 according to one non-limiting aspect of the present disclosure. According to the non-limiting aspect of FIG. 3, the robot 100 has been modularly outfitted with an one or more alternate wheels 114, each of which has a textured surface 112 on an outer surface. As such, the textured surface 112 of the wheels 114 can increase the amount of friction and/or traction generated between the wheels 114 and a surface of the operating environment (e.g., a pipeline), thereby improving the mobility of the robot 100, compared to the mobility provided by the wheels 104 of FIG. 1.

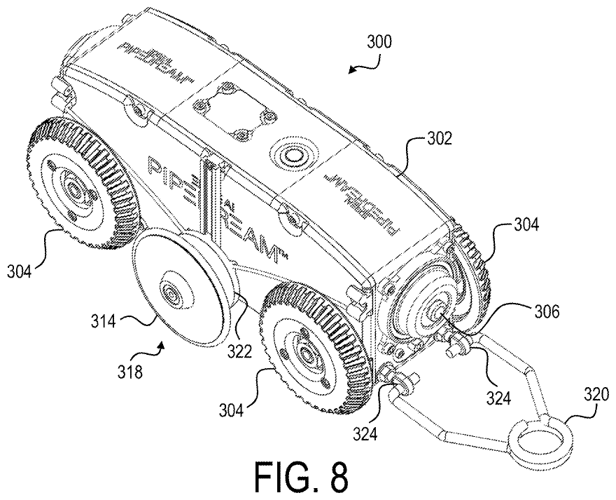

According to the non-limiting aspect of FIGS. 1-3, the robot 100 can include a state-of-the-art odometry system derived from an encoder positioned on (or within) one or more of the wheels 104. For example, it might be preferable to employ four independent wheel 104 encoders, which may include an internal inertial measurement unit (“IMU”) and/or a visual odometry system configured to produce a best-in-class fused linear position estimate of the robot's 100 position within the operating environment (e.g., a pipeline). The positional estimates generated by the encoders can be configured to comply with certain requirements, including those imposed by the Pipeline Assessment Certification Program (“PACP”). For example, the encoders employed via the wheels 104 of the robot 100 of FIGS. 1-3 can generate positional estimates that are less than or equal to once percent error as a function of linear distance traversed by the robot 100. According to some non-limiting aspects, a similarly configured encoder 318 can be positioned external the wheels 110 and mechanically coupled to a side of the robot 100, as will be described in further detail with reference to the robot 300 of FIG. 8.

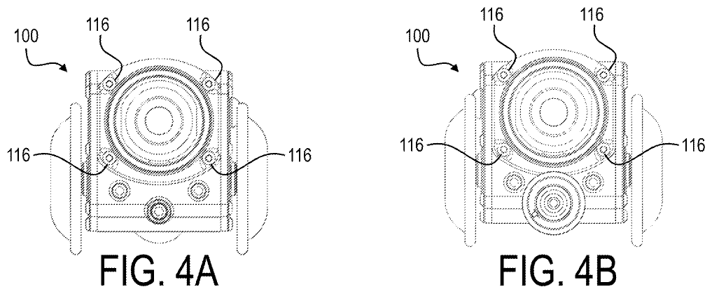

Referring now to FIGS. 4A and 4B, a front and back view of the disposable, carbon-neutral, minimally invasive robot of FIG. 1 are depicted, respectively, in accordance with at least one non-limiting aspect of the present disclosure. For example, FIG. 4A depicts a front view of the robot 100, including four electro-mechanical connections 116 configured to affix one or more modular sensors 106 to the robot 100. For example, the electro-mechanical connections 116 can include tapped holes, bolts, “quick connects,” and/or any other means by which the one or more sensors 106 can be mechanically coupled to the robot 100. However, mechanically coupling the sensors 106 to the robot 100 will also establish electrical communication between the sensor 106 and the power source of the robot 100. The backside of the robot 100 can also include such electro-mechanical connections 116, as depicted in FIG. 4B.

According to the non-limiting aspect of FIGS. 4A and 4B, it shall be appreciated that the sensor 106 can be swapped out in the field used, for example, only an Allen wrench. Thus, selectively detaching and reattaching a sensor 106 to the robot 100 does not require any electrical work in the field, such as establishing electrical connections or soldering, thereby increasing efficiency of use of the robot 100. Furthermore, as will be described in further detail herein, a self-awareness module 902 of the system will recognize the addition of any new, and possibly different, sensor 106 and configure the sensor 106 to collect data appropriately, as will be described in further detail with reference to FIG. 20. This can be accomplished without requiring any intervention and/or interaction from the user, absent the physical swap out of the sensor 106, itself. It shall be appreciated, however, that according to other non-limiting aspects, one or more of the electro-mechanical connections 116 can be dedicated to mechanically secure and/or electrically power one or more of the accessories, as will be described in further detail herein.

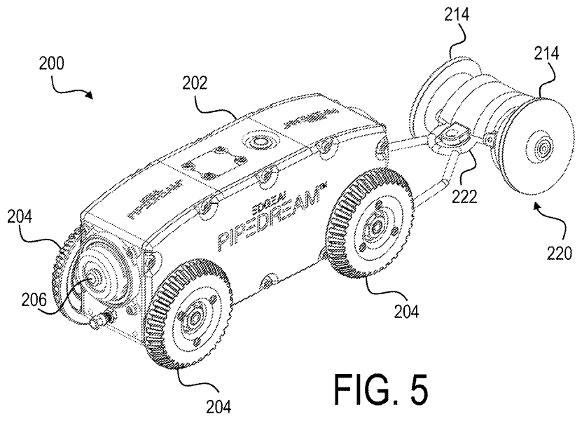

Referring now to FIG. 5, a perspective view of another disposable, carbon-neutral, minimally invasive robot 200 is depicted in accordance with at least one non-limiting aspect of the present disclosure. Similar to the robot 100 of FIG. 1, the robot 200 of FIG. 2 can include a machine-block housing 202, one or more wheels 204 as a primary moving device of the robot 200, and one or more sensing devices 206 (e.g., a camera, structured light, microphones, optical sensors, a RADAR sensor, a SONAR sensor, a LiDAR sensor, etc).

However, according to the non-limiting aspect of FIG. 5, the robot 200 can further include a precise positioning system 220. Whereas the encoders employed by one or more wheels 104 of the robot 100 of FIG. 1 can generate positional estimates configured to comply with certain requirements, including those imposed by the PACP, enhanced precision may still be required depending on user preference and/or intended application. For example, the estimates generated by the encoders deployed by the wheels 104 of the robot 100 of FIG. 1 may not be capable of providing survey-grade linear position estimates, nor can such encoders provide three-dimensional position and estimate (“pose”) information associated with the robot 100. The precise positioning system 220 of the robot 200 of FIG. 5 can remedy this defect by further enhancing the precision of pose estimates generated by the robot 200.

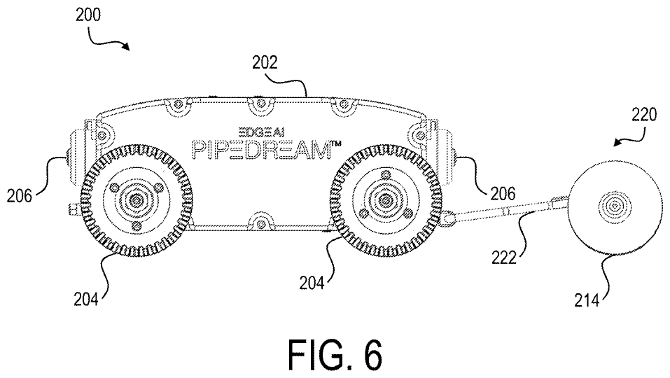

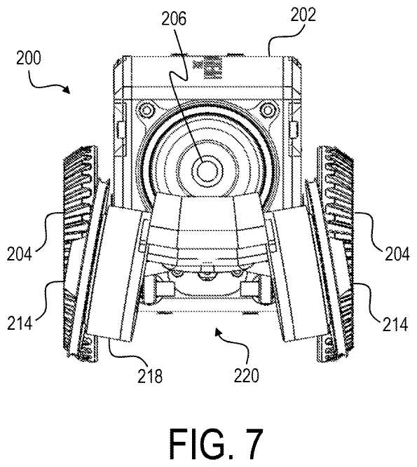

Similar to the encoders employed by the wheels 104 of the robot 100 of FIG. 1, the precise positioning system 220 of the robot 200 of FIG. 5, for example, can include a state-of-the-art odometry system derived from four independent wheel encoders, an internal IMU, and a visual odometry system to produce a best-in-class fused linear position estimate. However, the precise positioning system 220 of FIG. 5 can include additional sensors (e.g., IMUs, LiDARs, RADARs, SONARs, cameras, etc.) beyond odometers, including be further configured to provide additional accuracy to the linear position estimates, including three-dimensional pipeline pose information that is suitable for precise engineering rehabilitation analysis and survey grade localization. According to the non-limiting aspect of FIG. 5, the precise positioning system 220 can be configured as a cart that can be mechanically coupled to a front or back side of the robot 200, via one or more a connection similar to the electro-mechanical connections 116 of FIGS. 4A and 4B, or via a retrieval ring 222 mechanically coupled to either the front or the back of the robot 500, as will be described in further detail with reference to the robot 300 of FIG. 8. This is further depicted in FIGS. 6 and 7, which depict a side and back view of the disposable, carbon-neutral, minimally invasive robot of FIG. 5 of the disposable, carbon-neutral, minimally invasive robot of FIG. 5, respectively.

As depicted in FIGS. 5-7, the precise positioning system 220 can be configured to function as a passive mobility device. In other words, the precise positioning system 220 can include its own dedicated wheels 214, which can be configured to drag behind the robot 200 as the inspection is being performed. Passive mobility is important, as the differential odometry on the precise positioning system 220 can suffer much less wheel slip, as its wheels 204 are free spinning without interference from an encoder, which is positioned within a housing 218 coupled to the wheels 214 of the precise positioning system 220. As opposed to the robot 100 of FIG. 1, wheel 204 slippage is far less likely to occur with the robot 200 of FIGS. 5-7. Thus, the precise positioning system 220 can consequentially provide a much more accurate odometry estimate. This odometry estimate can be fused with IMU data generated via an IMU positioned onboard the robot 200, such as within the housing 218, thereby significantly improving linear position estimates. Furthermore, the precise positioning system 220 can be used to detect wheel 204 slippage on the robot 200, which has other benefits beyond positioning, including advanced proprioceptive sensing and other features of the self-awareness and pipeline awareness modules.

For example, merely accurate linear positioning is the minimum requirement for PACP inspections, as previously described. However, mere accuracy may be insufficient for many rehabilitation projects, as locational accuracy alone does not provide sufficient information to perform a plan view locational (e.g., two-dimensional) or full three-dimensional pipe geolocation effort. Thus, where three-dimensional information is necessary, the precise positioning system 220 of the robot 200 of FIGS. 5-7 can provide a low-cost, accurate means to perform three-dimensional pipe locations. This capability can be provided via an advanced inertial navigation system (“INS”) and/or an odometry system configured to create a fused position estimate in three-dimensional space, as described in further detail below. For example, when coupled with the global positioning system (“GPS”) generated locations of the invert of the upstream and downstream manhole, this can provide an advanced survey grade geolocation of the entire extent of the pipeline, including precision location of the manhole as part of the inspection service. In other aspects, the precise positioning cart can be configured with additional sensors, including a sonde locator for the location of shallow pipe using traditional means, radar, sonar, or other non-destructive sensors or testing apparatus.

Referring now to FIG. 8, a perspective view of another disposable, carbon-neutral, minimally invasive robot 300 is depicted in accordance with at least one non-limiting aspect of the present disclosure. Similar to the robots 100, 200 of FIGS. 1 and 5, the robot 300 of FIG. 8 can include a machine-block housing 302, one or more wheels 304 as a primary moving device of the robot 300, and one or more sensing devices 306 (e.g., a camera, structured light, microphones, optical sensors, a RADAR sensor, a SONAR sensor, a LiDAR sensor, etc). However, according to the non-limiting aspect of FIG. 8, the robot 300 can further include an accessory, in the form of a sidecar 318. The sidecar 318, as previously explained can include encoders, similar to those employed in the wheels 104 of the robot 100 of FIG. 1 and the precise positioning system 220 of the robot 200 of FIG. 5. However, in cases where more precision is required than capable of the encoders in the wheels 104 of the robot 100 of FIG. 1 and it isn't possible to deploy the precise positioning system 220 of the robot 200 of FIG. 5 due to pipe conditions (e.g., due to accumulated sediment), the sidecar 318 of the robot 300 of FIG. 8 is ideal.

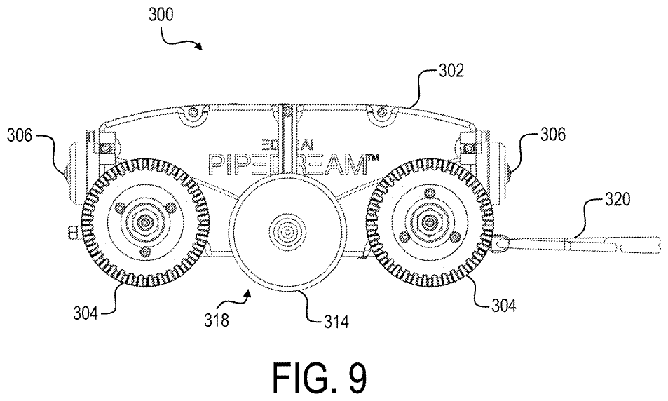

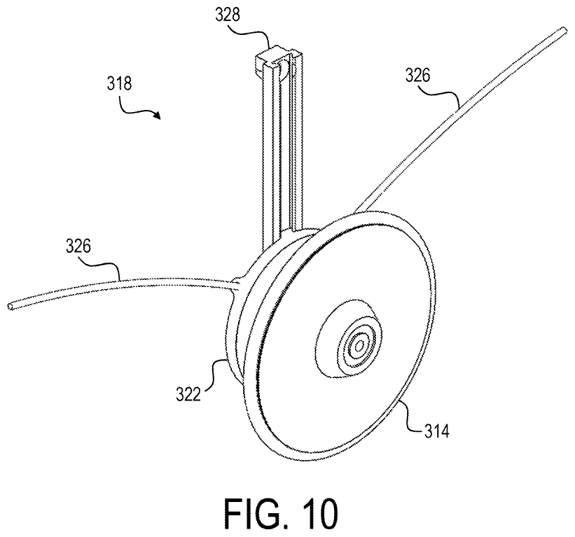

Similar to the precise positioning system 220 of the robot 200 of FIG. 5, the sidecar 318 of the robot 300 of FIG. 8 can be passively configured, so it provides superior linear odometry from a passive wheel 314. However, according to the non-limiting aspect of FIG. 8, the sidecar 318 can further include a tensioning mechanism 322, specifically configured to apply an inverted pressure to the passive wheel 314, such that the passive wheel 314 is pressed into a surface of the pipe as the robot 300 traverses through it. The sidecar 318 is depicted in further in FIGS. 9 and 10, which show a side view of the disposable, carbon-neutral, minimally invasive robot 300 of FIG. 8 and a perspective view of the sidecar 310, respectively. Additionally, the non-limiting aspect of FIG. 8 depicts a retrieval ring 320 of the robot 300 in further detail. Similar to the retrieval ring 222 of the robot 200 of FIG. 5, the retrieval ring 320 can be configured to mechanically couple to one or more accessories described herein. However, the retrieval ring 320 can be further configured with an annular component positioned at a proximal end of the robot 300 such that the robot can be “retrieved,” that is, fished out of an operating environment with an ancillary tool, as needed. Moreover, FIG. 8 depicts how the robots 100, 200, 300 disclosed herein can include one or more mechanical connections 324 by which accessories, such as the retrieval ring 320, can be mechanically coupled to the robots 100, 200, 300 disclosed herein. Accordingly, it shall be appreciated that the accessories disclosed herein can be modularly configured for selective engagement with any of the robots 100, 200, 300 of FIGS. 1, 5, and 8.

According to FIGS. 9 and 10, the sidecar 318 of the robot 300 is depicted in further detail. Specifically, the passive wheel 314, which is specifically configured for odometry, is illustrated relative to the other wheels 304 and housing 302 of the robot 300. As depicted in FIG. 10, the tensioning mechanism 322 of the sidecar 318 can include two whiskers 326, which can be pre-tensioned to provide the necessary force to keep the passive wheel 314 securely pressed against a pipe invert as the robot 300 traverses the operating environment. According to some non-limiting aspects, the whiskers 326 can be mechanically coupled to a motor internal or external to the robot such that tension provided by the whiskers 326 can be adjusted in real-time. It shall be appreciated that, according to some non-limiting aspects, the whiskers 326 should be tensioned such that the passive wheel 314 can “slide,” such that debris or obstruction doesn't overly bind the robot 300 during motion. In other words, if the robot 300 encounters debris, the slide of the passive wheel 314 can enable the passive wheel 314 to be pressed up towards the pipe crown, increasing the effective ground clearance for the robot 300 and improving mobility of the robot 300 dramatically over a fixed linear position.

Although the non-limiting aspects of FIGS. 8-10 illustrate a single sidecar 318 employed by the robot 300, it shall be appreciated that, according to other non-limiting aspects, the robot 300 can include two or more sidecars 318. For example, the robot 300 can be similarly outfitted with a second sidecar 318 on an opposite side of the robot 300 depicted in FIG. 9 of the present disclosure. Alternately or additionally, one or more sidecars 318 can be complemented with a precise positioning system 220 of the robot 200 of FIGS. 5-7, which can be selectively coupled to the retrieval ring 320, according to some non-limiting aspects. This can provide a user with the ability to increase the accuracy of the spatial indexing of inspection data to satisfy the requirements for general condition assessment, engineering grade assessment, or survey-grade localization with simple, easy to interface supplemental positioning systems.

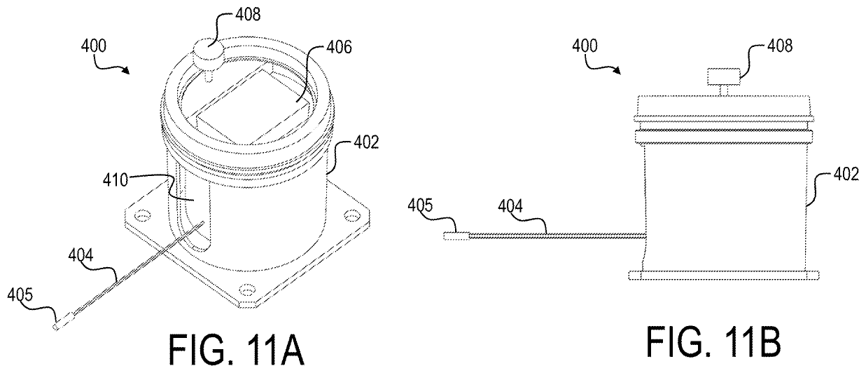

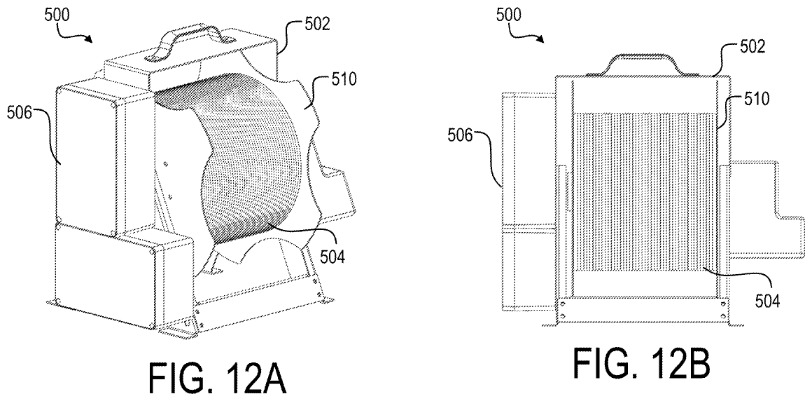

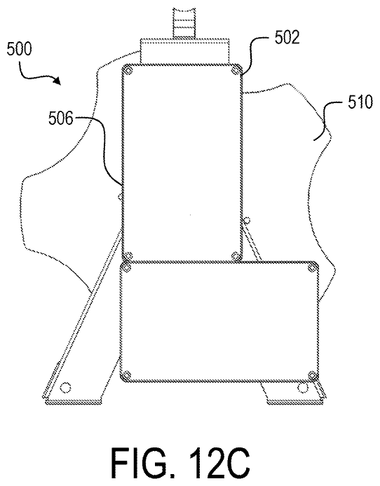

Referring now to FIGS. 11A and 11B, a perspective and side view of another accessory configured for use with the disposable, carbon-neutral, minimally invasive robots 100, 200, 300 (FIGS. 1, 5, and 8) disclosed herein are respectively depicted in accordance with at least one non-limiting aspect of the present disclosure. According to the non-limiting aspects of FIGS. 11A and 11B, the accessory can include an intelligent, or “smart,” tether 400. The tether 400 can be “smart,” via the use of markers to track linear position of the robot through the pipe, as will be described in further detail herein. This can further enhance the precision of generated pose info by divorcing the determination of a pose from the possibility of wheel 104, 204, 304 (FIGS. 1, 5, and 8) slip. Also, because the line 404 of the tether 400 can be made from a fiber optic material, it can be multi-purpose. For example, transmission of optic signals through the line 404 can be used to measure whether the tether is crimped via the backscatter on the fiber, or via a birefringent pattern generated by the line 404. The fiber of the line 404 can also be used to listen for loud noises and other environmental conditions within the operating environment. Understanding the tension on the cable, in conjunction with the use of markers, such as the RFID tags disclosed here, can provide a lot of enhanced positioning information.

The tether 400 of FIGS. 11A and 11B can be configured as a bucket suitable for standard, less industrial applications. Specifically, the bucket-shape of the tether 400 is provided via an external housing 402 that covers the line 404, which can be coiled about an interior reel 410, including a slip ring, and/or electronics assembly 406 of the tether 400. The electronics assembly 406, for example, can include a computing device, a radio and/or associated transceivers, a power source (e.g., batteries), and/or a external power assembly (e.g., shore power, such as wall-outlet, etc.) configured to provide power when another power source is unavailable.

According to some non-limiting aspects, the tether 400 of FIGS. 11A and 11B can further include a motor and motor controller that can automate some tether functions like retrieval of the robot 100, 200, 300 (FIGS. 1, 5, and 8), autonomous line 404 management and tensioning, and support for multi-segment hopping and tether 400 quick swap capabilities. In various aspects, the physical medium for the line 404 can include an optical fiber, but any combination of copper (e.g., for power, communications, etc.) and fiber (e.g., higher speed communications relative to copper, etc.) is possible. For example, multi-segment configurations may implicate multiple tethers 400 and a single robot 100, 200, 300 (FIGS. 1, 5, and 8), such that the robot 100, 200, 300 (FIGS. 1, 5, and 8) can be disconnected from a first tether 400 and reconnected to a second tether 400 in the field, eliminating the need for multi-deployment missions. This, according to some non-limiting aspects, can be robotically automated via an actuator of the robot 100, 200, 300 (FIGS. 1, 5, and 8) or a deployment garage 600, 700 (FIGS. 11A and 12A). According to other non-limiting aspects, the line 404 can be configured to include a transport layer that supports relatively high-speed Ethernet communications (e.g., via fiber, copper, coaxial cable, and/or combinations thereof).

Still referring to FIGS. 11A and 11B, the tether 400 can further include a hand crank 408. The hand crank 408, for example, can be configured to manually reel the line 404 of the tether 400 back into the housing 402, as the means of primary robot 100, 200, 300 (FIGS. 1, 5, and 8) retrieval and cable management. However, as previously described, according to some non-limiting aspect, the tether 400 can further include a motor to supplement or supplant the hand crank 408 with automated retrieval for a reduction of physical exertion required of the user. According to such aspects, the motor can be configured in conjunction with motion of the robot 100, 200, 300 (FIGS. 1, 5, and 8) to provide mobility assistance to the robot 100, 200, 300 (FIGS. 1, 5, and 8) during retrieval. Furthermore, as depicted in FIGS. 11A and 11B, the housing 402 of the tether 400 can be configured to be mechanically secured to a foundation, for example, by being bolted down via one or more holes defined by the housing 402 or other standard connections, thereby improving ergonomics and site safety.

With specific reference to FIG. 11B, the tether 400 is depicted from a side, or profile, view. It shall be appreciated that the line 404 can include a quick connection 405 at a distal end, wherein the quick connection 405 can be specifically configured to be mechanically coupled to a portion of the robot 100, 200, 300 (FIGS. 1, 5, and 8). In this view, the line 404 and quick connection 405 are shown extending from the mouth of the housing 402, which contains the interior reel 410, or line 404 spool. The rugged, low-cost deployment of the tether 400 of FIGS. 11A and 11B can be provided separately or along with the robot 100, 200, 300 (FIGS. 1, 5, and 8) and can be configured to, according to some non-limiting aspects, support up to 500 linear feet of shielded, strengthened line 404 (e.g., structural, optical, electrical communications, etc).

Referring now to FIGS. 12A-C, a perspective, front, and side view of another accessory configured for use with the disposable, carbon-neutral, minimally invasive robots 100, 200, 300 (FIGS. 1, 5, and 8) disclosed herein are depicted, respectively, in accordance with at least one non-limiting aspect of the present disclosure. Similar to the non-limiting aspects of FIGS. 11A and 11B, the accessory of FIGS. 12A-C can include an intelligent, or “smart,” tether 500, which can include any or all of the features of the tether 400 of FIGS. 11A and 11B. For example, the tether 500 can include an external housing 502 that covers the line 504, which can be coiled about an interior reel 510, including a slip ring, and/or electronics assembly 506 of the tether 500. However, according to the non-limiting aspect of FIGS. 12A-C, the tether 500 can include critical upgrades, which improve the overall reliability, cable management, performance, and site safety provided by the tether 500. For example, beyond a hand crank, the tether 500 of FIGS. 12A-C can be motorized and can support longer line 504 for further distances. The tether 500 can further include additional support features for customers with more demanding use requirements. For example, the tether 500 of FIGS. 12A-C may be more suitable for contractors or larger municipalities that demand a higher level of performance and can afford a higher price point.

The tethers 400, 500 of FIGS. 11A and 11B and FIGS. 12A-C can provide highly precise distance measuring (in millimeters, for example) over arbitrary lengths of line 504. The tether 500 can, therefore, eliminate drift by placing an absolute position marker on the line 504 that is fused to a specific, quantifiably known location of the line 504. These markers, for example, can include passive radio-frequency identifier (“RFID”) tags that are fused to the line 504 at standard intervals (e.g., every one meter, two meters, five meters, etc.). A unique identifier of each tag can be associated with its absolute fused position on the cable, meaning that every time the segment of the line 504 with an RFID tag pass through a receiver ring that includes an active RFID scanner on the tether 500 or housing 502, all cumulative error is zeroed out at that point.

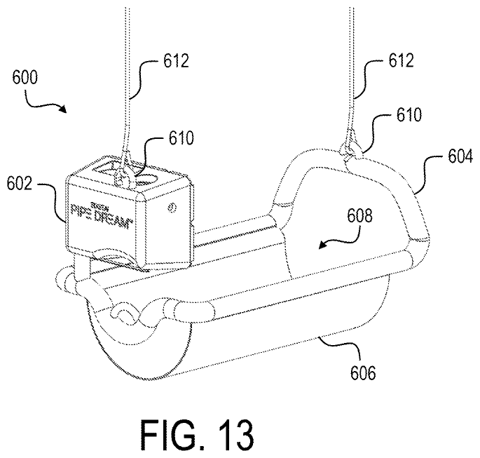

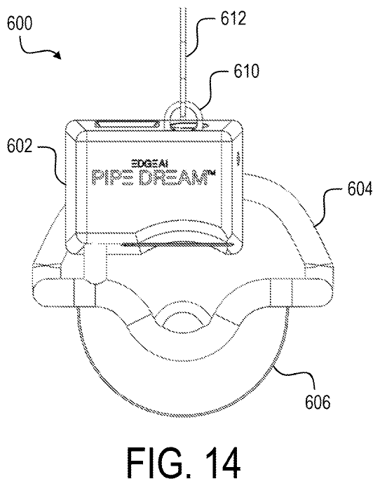

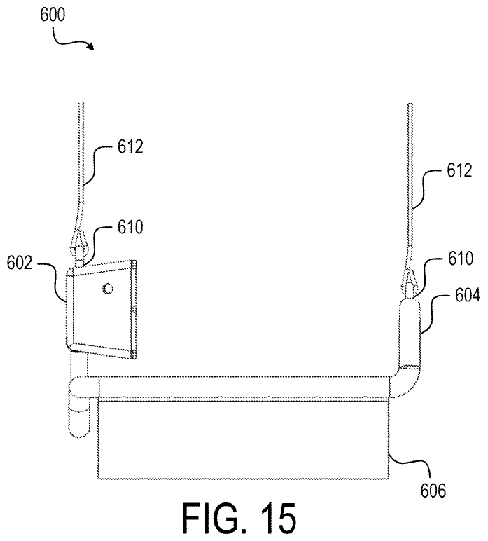

Referring now to FIGS. 13-15, a perspective, front, side, and top view of another accessory configured for use with the disposable, carbon-neutral, minimally invasive robots 100, 200, 300 (FIGS. 1, 5, and 8) disclosed herein are depicted, respectively, in accordance with at least one non-limiting aspect of the present disclosure. According to the non-limiting aspect of FIGS. 13-16, the accessory can include a deployment garage 600 configured to deploy any of the robots 100, 200, 300 (FIGS. 1, 5, and 8) disclosed herein within an operating environment. It shall be appreciated that, lowering the robots 100, 200, 300 (FIGS. 1, 5, and 8) via a tether 400, 500 (FIGS. 11A, 11B, and 12A-C) mechanically coupled to a retrieval ring 222, 320 (FIGS. 5 and 8) could potentially damage one or more of the sensors 106, 206, 306 of the robots 100, 200, 300 (FIGS. 1, 5, and 8). For example, according to non-limiting aspects wherein the one or more sensors 106, 206, 306 (FIGS. 1, 5, and 8) include a camera on the front of the robots 100, 200, 300 (FIGS. 1, 5, and 8), the camera may be at high risk for impact with a pipe invert during deployment. Although the present disclosure further contemplates non-limiting aspects wherein a retrieval ring 222, 320 (FIGS. 5 and 8) is alternately positioned on a top side of the robots 100, 200, 300 (FIGS. 1, 5, and 8), which can reduce the risk of damaged sensors 106, 206, 306 (FIGS. 1, 5, and 8) via deployment. Absent the deployment garage 600 of FIGS. 13-16, the robot 100, 200, 300 (FIGS. 1, 5, and 8) may suffer damages damages during deployment, including cracked lenses, broken cameras, and waterlogging, amongst others.

According to FIGS. 13-15, the deployment garage 600 can include a frame 604 from which a carriage 606 configured to contain a robot 100, 200, 300 (FIGS. 1, 5, and 8) upon deployment can suspend. The frame 604 can include one or more mechanical connections 610 to which one or more lines 612 can be coupled, such that the lines 612 can be used to deploy the garage 600 and thus, a robot 100, 200, 300 (FIGS. 1, 5, and 8) positioned within the carriage 606. At least one end of the frame 604 and carriage 606 can be configured to define an aperture 608 through which the robot 100, 200, 300 (FIGS. 1, 5, and 8) can egress the garage 600 upon deployment. The garage 600 can further include a computing device 602 which can be similarly configured with the sensors and modules of the robot 100, 200, 300 (FIGS. 1, 5, and 8) to communicate with the robot 100, 200, 300 (FIGS. 1, 5, and 8) or a computing device of a ground control station, sense the robot 100, 200, 300 (FIGS. 1, 5, and 8), the tether, or the operating environment. In other words, the deployment garage 600 of FIGS. 13-15 is specifically configured to secure and protect the robot 100, 200, 300 (FIGS. 1, 5, and 8) during deployment into an operating environment, including the protection of the one or more sensors 106, 206, 306 (FIGS. 1, 5, and 8), which may include highly vulnerable camera lenses.

It shall be appreciated that the deployment garage 600 of FIGS. 13-15 can be a part of the improved pipeline inspection system, but can also be thought of as a supplemental or optional component depending on the specifics of the inspection operations. This deployment garage 600 of FIGS. 13-15 can provide several important benefits to both the operator, the inspection device, and the overall inspection operation. Moreover, the deployment garage 600 can be configured to function as a multifunctional support device that is provided to increase the safety and efficiency of inspection operations, as well as to protect the inspection device during the deployment. Moreover, via the inclusion of the computing device 602, the deployment garage 600 is not merely configured to function as a mechanical device. Rather, the computing device 602 of the deployment garage 600 can be configured to store an artificial intelligence algorithm or model, similar to the robots 100, 200, 300 (FIGS. 1, 5, and 8), as will be described in further detail with reference to FIG. 20. Thus, the deployment garage 600 can be intelligently configured to provide additional support functions that are very useful in certain types of inspection operations, as described below.

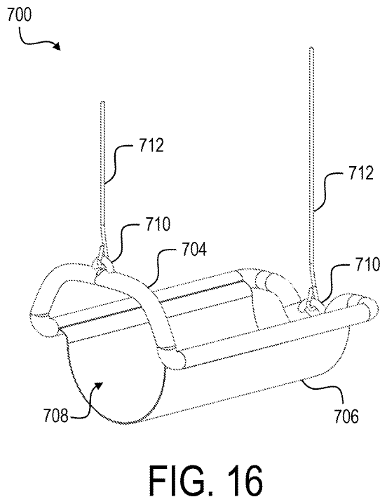

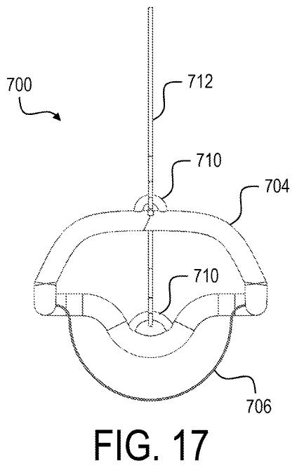

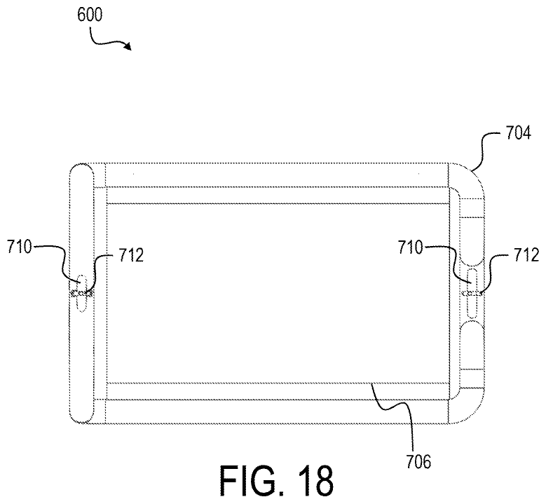

Referring now to FIGS. 16-18, a perspective, front, and top view of another accessory configured for use with the disposable, carbon-neutral, minimally invasive robots disclosed herein are depicted, respectively, in accordance with at least one non-limiting aspect of the present disclosure. According to the non-limiting aspect of FIGS. 16-18, the accessory can include a deployment garage 700 configured to deploy any of the robots 100, 200, 300 (FIGS. 1, 5, and 8) disclosed herein within an operating environment. Similar to the deployment garage 600 of FIGS. 13-16, the deployment garage 700 can include a frame 704 from which a carriage 706 configured to contain a robot 100, 200, 300 (FIGS. 1, 5, and 8) upon deployment can suspend. The frame 704 can include one or more mechanical connections 710 to which one or more lines 712 can be coupled, such that the lines 712 can be used to deploy the garage 700 and thus, a robot 100, 200, 300 (FIGS. 1, 5, and 8) positioned within the carriage 706. At least one end of the frame 704 and carriage 706 can be configured to define an aperture 708 through which the robot 100, 200, 300 (FIGS. 1, 5, and 8) can egress the garage 700 upon deployment.

However, unlike the deployment garage 600 of FIGS. 13-15, the deployment garage 700 of FIGS. 16-18 does not include a computing device 602. Although, according to some non-limiting aspects, a computing device 602 similar to that shown in FIGS. 13-15 can be included, the deployment garage 700 of FIGS. 16-18 more specifically depicts an attenuated structural configuration for a deployment garage 700. For example, the deployment garage 700 of FIGS. 16-18 includes mechanical connections 710 that are vertically offset relative to one another, thereby balancing a loaded weight of the deployment garage 700. Accordingly, the deployment garage 700 of FIGS. 16-18 can also be configured to secure and protect the robot 100, 200, 300 (FIGS. 1, 5, and 8) during deployment into an operating environment, including the protection of the one or more sensors 106, 206, 306 (FIGS. 1, 5, and 8), which may include highly vulnerable camera lenses.

It shall be appreciated that, although a deployment garage, including those deployment garages 600, 700 depicted in FIGS. 13-18, is not required for manual operation of the robots 100, 200, 300 (FIGS. 1, 5, and 8), they may be utilized for tether-less operation. For example, the deployment garages 600, 700 of FIGS. 13-18 can include an electronic communication relay (e.g., embedded within a computing device 602, for example), which can be configured to serve as a primary means of communication between the robots 100, 200, 300 (FIGS. 1, 5, and 8) and a human interface positioned remotely relative to the robots 100, 200, 300 (FIGS. 1, 5, and 8) (e.g., at the ingress and/or egress manhole). However, according to non-limiting aspects where the robots 100, 200, 300 (FIGS. 1, 5, and 8) are autonomously configured, a deployment garage 600, 700, such as those depicted in FIGS. 13-18, can be also viewed as optional.

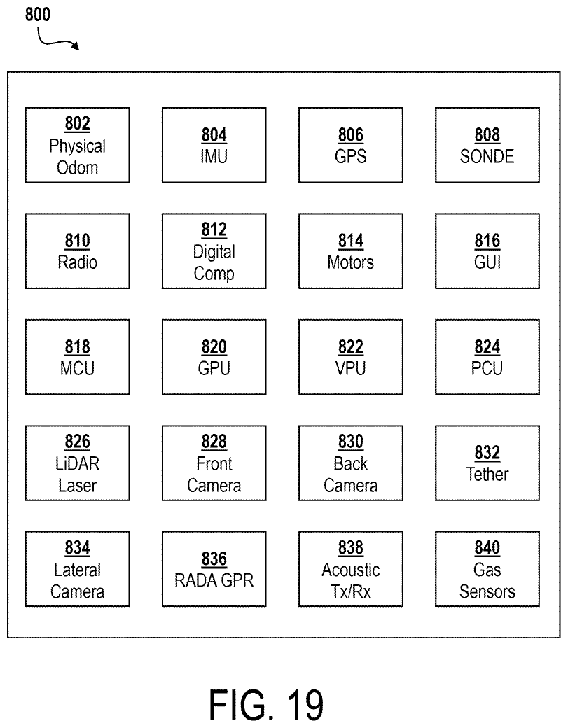

Referring now to FIG. 19, a block diagram of a hardware architecture 800 configured for use with the disposable, carbon-neutral, minimally invasive robots 100, 200, 300 (FIGS. 1, 5, and 8) disclosed herein is depicted in accordance with at least one non-limiting aspect of the present disclosure. According to the non-limiting aspect of FIG. 19, the architecture 800 can include a physical odometer 802 an IMU 804, a GPS 806, or a SONDE 808, any of which can be implemented via the robots 100, 200, 300 (FIGS. 1, 5, and 8) disclosed herein. For example, according to some non-limiting aspects, the physical odometer 802 an IMU 804, a GPS 806, and/or a SONDE 808 can be internal components of the encoders (FIG. 1), precise positioning system 220 (FIG. 5), and sidecars 318 (FIG. 8), as previously discussed.

The architecture 800 of FIG. 19 can further include a radio 810, a digital computer 812, and/or one or more motors 814 configured to turn the aforementioned wheels 104, 204, 304 of the robots 100, 200, 300 (FIGS. 1, 5, and 8). For example, the digital computer 812 can be configured to autonomously command the motors 814 to turn the aforementioned wheels 104, 204, 304, thereby enabling autonomous control of the of the robots 100, 200, 300 (FIGS. 1, 5, and 8). Alternately, signals received by the radio 810 from a remote computing device can be used to command the motors 814 to turn the aforementioned wheels 104, 204, 304, thereby enabling remote control of the of the robots 100, 200, 300 (FIGS. 1, 5, and 8). According to some non-limiting aspects, a graphical user interface (“GUI”) 816 can be displayed via the digital computer 812 and/or a remote computing device to facilitate such control.

In further reference to FIG. 19, the architecture 800 can further include a processing unit, which can include a microcontroller unit (“MCU”) 818, a graphics processing unit (“GPU”) 820, a vision processing unit (“VPU”) 822, and/or a portable computing unit (“PCU”) 824, any of which can be positioned onboard the robot 100, 200, 300 (FIGS. 1, 5, and 8) or, alternately, positioned remotely relative to the robot 100, 200, 300 (FIGS. 1, 5, and 8). Importantly, these processing units 818, 820, 822, 824 need only be communicably coupled to at least a portion of the system architecture 800 via conventional wireless or wired means of communication. For example, according to some non-limiting aspects, any of the aforementioned processing units 818, 820, 822, 824 may require inputs from one or more systems of the robots 100, 200, 300 (FIGS. 1, 5, and 8), including a LiDAR laser 826, a front camera 828, a back camera 830, a lateral camera 834, a RADA GPR 836, and/or a gas sensor 840, such that the system can generate information based on signals generated by one or more sensors of the robots 100, 200, 300 (FIGS. 1, 5, and 8). The architecture 800 can further include a tether system 832, as previously disclosed with reference to FIGS. 11A-12B and/or an acoustic transmitter and/or receiver 838 configured to characterize an operating environment and identify positional threats to the robot 100, 200, 300 (FIGS. 1, 5, and 8).

Referring now to FIG. 20, a software stack 900 configured for use with the disposable, carbon-neutral, minimally invasive robots 100, 200, 300 (FIGS. 1, 5, and 8) disclosed herein is depicted in accordance with at least one non-limiting aspect of the present disclosure. According to the non-limiting aspect of FIG. 20, the software stack 900 can include a representation an reporting manager 902, a cloud, portal and social media manager 904, a pipeline analytics AI core 906, a position analytics core 908, a pipeline awareness core 910, an integrated video and sensing analysis module 912, a LiDAR analytics module 914, a RADAR analytics module 916, an environmental analytics module 918, and a self awareness module 920, any of which can be stored in any of the aforementioned computing devices communicably coupled to the robots 100, 200, 300 (FIGS. 1, 5, and 8) disclosed herein. For example, any portion of the software stack 900 of FIG. 20 can be stored and accessed by the digital computer 812 (FIG. 19) of the system and/or executed by any of the processing units 818, 820, 822, 824 (FIG. 19) of the system. Additionally, according to some non-limiting aspects, any portion of the software stack 900 of FIG. 20 can be stored remotely relative to the robots 100, 200, 300 (FIGS. 1, 5, and 8), yet deployed by the system for the benefit of the robots robots 100, 200, 300 (FIGS. 1, 5, and 8) nonetheless.

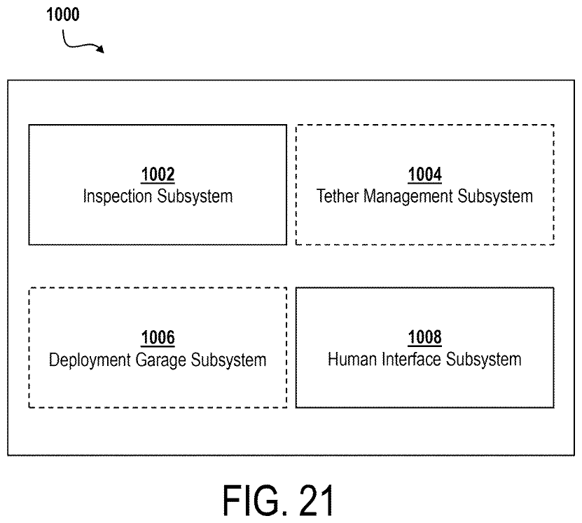

It shall be appreciated that, according to some non-limiting aspects, any of the aforementioned hardware or software components of the architecture 800 and/or stack 800 of FIGS. 19 and 20 can be organized into one or more subsystems of the robots 100, 200, 300 (FIGS. 1, 5, and 8). For example, according to the non-limiting aspect of FIG. 21, an improved pipeline inspection system 1000 can include a plurality of separate and discrete subsystems 1002, 1004, 1006, 1008 configured to work in concert. For example, according to the non-limiting aspect of FIG. 21, the system 1000 can include an inspection subsystem 1002, a tether management subsystem 1004, a deployment garage subsystem 1006, and/or a human interface subsystem 1008. As previously described, the tether management subsystem 1004 and/or the deployment garage subsystem 1006 can be optional, depending on user preference and/or intended application.

Based on the above description, it is clear that the present disclosure contemplates an improved pipeline inspection system 1000 (FIG. 21) configured to function as a modular platform design that draws on a hardware architecture 800 (FIG. 19) and a software stack 900 (FIG. 20), both of which can be selectively implemented and/or actuated to customize a use of the system 1000 (FIG. 21). Each aspect of the improved pipeline inspection system 1000 (FIG. 21) is realized in this manner. In other words, the hardware architecture 800 (FIG. 19) and software stack 900 (FIG. 20) are conceived of in such a manner that different realizations of the improved pipeline inspection system 1000 (FIG. 21) can be drawn from the core invention platform in a “bag-of-words” fashion. Functionality required for a given realization can be assembled from core platform components in a modular fashion. The core platform consists of a hardware architecture 800 (FIG. 19) and software stack 900 (FIG. 20) that reside on and control the robots 100, 200, 300 (FIGS. 1, 5, and 8) required to power a given platform driven, modular capability implementation.

As can be seen from FIG. 20, the software stack 900 (FIG. 20) can include twelve components that are engineered and performance optimized to realize the invention of a small waste and storm water pipe data collection and analytics system that can collect engineering and survey grade data in a carbon neutral form factor, all the while being disposable, minimally invasive, and carbon neutral. The twelve components can include, a Representation and Reporting Agent 902, a Cloud, Portal, and Social Media Agent 904, a Self-Awareness AI Core 920, Pipeline-Awareness AI Core 910; a Position Analytics AI Core 908, a Pipeline Analytics AI Core 906. However, according to other non-limiting aspects, the software stack 900 can further include an Integrated Guidance and Control (Standard), a 360 Squared Video Perception Module, Integrated Power Management, a Multi-Segment Inspection Module with Quick Swap or Smart Tether, Integrated, an Intelligent Deployment Garage, and Drift-Free Electro-Magnetic Position Measurement System.

The improved pipeline inspection system 100 (FIG. 21) can be arranged in order of services of increasing amounts of artificial intelligence deployed by the software stack 900 (FIG. 2) from the bottom of FIG. 20 to the top. At the top end this includes standard machine learning, deep learning neural networks, and in some cases quantum machine learning techniques. Advanced artificial intelligence-powered capabilities are enabled by the hardware edge computing infrastructure that is core to the platform approach. This embedded computing infrastructure relies heavily on advanced computing technologies, like compact GPU 820 (FIG. 19) and VPU 822 (FIG. 19) processors, in addition to traditional micro-controllers and computers.

The edge computing component of the improved pipeline inspection system is usually associated with traditional programmable computing and communication services that are available on a modern Central Processing Unit (“CPU”). In the case of the improved pipeline inspection system 1000 (FIG. 21), the traditional services are coupled with integrative MCU 818 (FIG. 19), GPU 820 (FIG. 19), VPU 822 (FIG. 19), and in some aspects a Quantum Processing Unit (“QPU”), which may be simulated or real. Each of these components, except for the QPU, is shown in FIG. 19. The edge computing components, along with the array of exteroceptive and proprioceptive sensors, as well as perception and mobility support for the bulk of the hardware components, is from which all aspects of the improved pipeline inspection system are constructed.

As previously mentioned, software and software-driven services are arranged in the software stack 900 of FIG. 20, which is arranged in a hierarchy that represents their relative level of support for dynamic adaptation that is the primary driver for infusing these types of systems with artificial intelligence. In the improved pipeline inspection system 1000 (FIG. 21), there are four primary layers of AI support in the form of specific packaging of software with respect it's level of artificial intelligence: 1) Modules; 2) Cores; 3) Managers (or Engines); and 4) XXX. The platform packages include the following:

Modules. The modules can be thought of as standard computing services that are constructed using traditional software development methods with minimal AI components Platform modules can be as simple as firmware and device drivers, or as complicated as full middleware solutions. A model in this platform description architecture is that it typically devoid of learning capability.

Cores. As the name suggests, these services represent core platform functionality and usually contain significant levels of machine learning. Platform cores are the central functional of this new generation of AI-powered devices and the heart of the platform centric approach to the improved pipeline inspection system.

Manager (or Engine). These blocks can be thought of as the integrative and functional brains for each aspect of the improved pipeline inspection system designed and implemented from the software and hardware platform. They may draw on any or all the underlying functionality, including that functionality provided by models and cores, from which they may synthesize sophisticated behaviors and, in some cases, even generate their own heuristic approaches to problem solving. These modules also may contain significant machine learning, in addition to any capabilities they draw on from the lower abstraction layers of the platform.

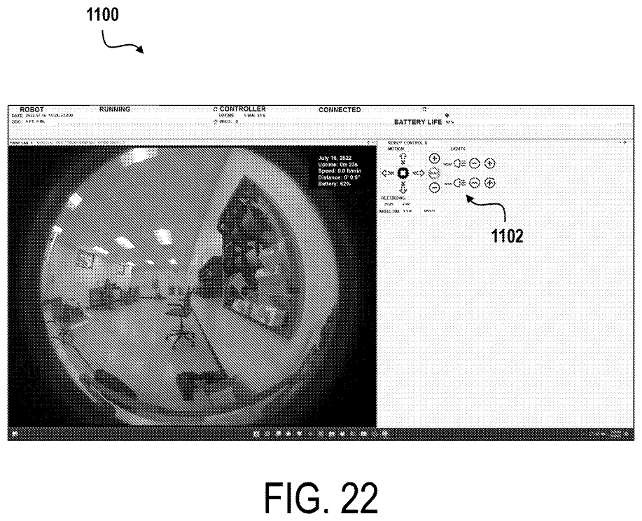

Referring now to FIG. 22, a human-machine interface 1100 configured for use with the disposable, carbon-neutral, minimally invasive robots 100, 200, 300 (FIGS. 1, 5, and 8) disclosed herein is depicted in accordance with at least one non-limiting aspect of the present disclosure. According to the non-limiting aspect of FIG. 22, the human-machine interface 1100 can include one or more controls 1102 by which the various subsystems, software, and hardware can be controlled, thereby presenting a viable means for remotely controlling the robots 100, 200, 300 (FIGS. 1, 5, and 8) disclosed herein. It will be appreciated that the operation of the improved pipeline inspection system 1000 includes an interaction between a human operator and the integrated robot system. This interface 1100 allows an operator to view the real-time images/videos captured by the inspection device, control the motion of the inspection device as well as the LED lighting for all cameras individually, retrieve inspection device status, set odometry starting point, input PACP inspection header information, initiate/stop inspections, and execute other related actions. The interface 1100 software operates to create an inspection data package with recorded videos, PACP header, and other related inspection data such as odometry, and upload inspection data package to the “Pipe Dream” cloud for future process without human intervention. The interface 1100 software maintains the local database in the inspection device and allows the operator to select which inspection date package(s) they would like to upload. This makes it possible to transfer the required large data packages only and reduce the usage of energy. Working with the sensors and native AI engines equipped in the inspection device, the interface 1100 software also provides situational alerts to the operator. The alerts include but are not limited to severe structure damage, abnormal environment parameters (temperature, pressure, toxic/explosive gases, etc.), unpassable conditions (drops, gaps, etc.), and so on. Working with the effectors, actuator, and motors equipped in the inspection device, the interface 1100 also allows the operator to execute maintenance operations in the pipe.

The human machine interface 1100 can allow users to log in to the system and view the live image/videos and system status remotely. This opens various possibilities such as remote diagnostics and evaluation by expert without the high business travel cost. Along with other components in the system, the software supports location and usage history logging for asset management purpose. Utilizing the powerful AI engines in the inspection device, the system 1000 (FIG. 21) can process captured sensor data, including but not limited to image/video, locally on the robot 100, 200, 300 (FIGS. 1, 5, and 8) and create evaluation summary including PACP coding and reports. This edge computation and processing capability eliminates the need of moving huge amounts of data around which makes the system more efficient and ecofriendly.

Accordingly, the improved pipeline inspection system 1000 (FIG. 21), including the previously described software stack 900 (FIG. 20) and hardware architecture 800 (FIG. 19), can be implemented via small pipe inspection robots 100, 200, 300 (FIGS. 1, 5, and 8) with the primary capabilities of disposability, minimal invasiveness, and carbon neutrality. In addition to all this, the improved pipeline inspection system will produce the capability to collect engineering and survey grade inspection data and subsequent analysis. The analysis includes AI powered analytics, reporting, and user engagement engines.

In at least one aspect, the improved pipeline inspection system 1000 (FIG. 21) includes a wheeled pipe inspection robot 100, 200, 300 (FIGS. 1, 5, and 8) that collects video from within an extruded engineering pipeline structure. Such a robot 100, 200, 300 (FIGS. 1, 5, and 8) can be configured to operate in small diameter wastewater, storm water, or dewatered pressure pipelines. Although the operating diameter of the robot 100, 200, 300 (FIGS. 1, 5, and 8) is not limited, according to such non-limiting aspects, the operating diameter of the robot 100, 200, 300 (FIGS. 1, 5, and 8) can be optimized for 6 inch to 18-inch pipelines.

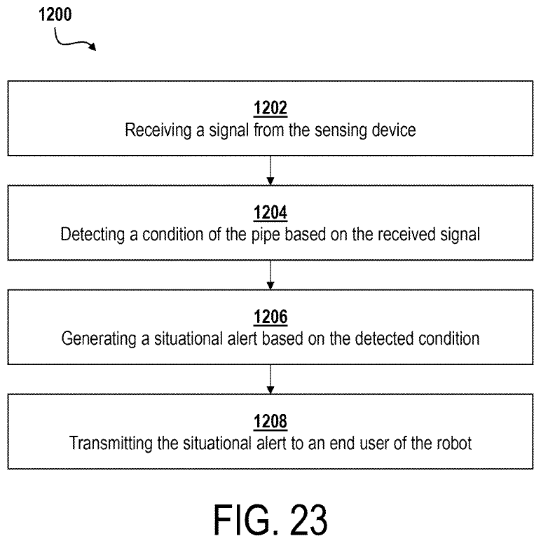

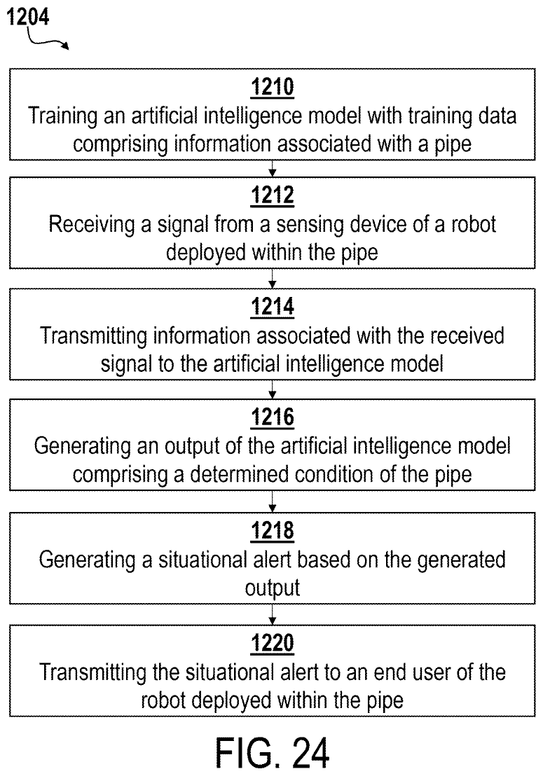

Referring now to FIG. 23, a logic flow of a method 1200 of generating and transmitting a situational alert via the disposable, carbon-neutral, minimally invasive robots 100, 200, 300 (FIGS. 1, 5, and 8) disclosed herein is depicted in accordance with at least one non-limiting aspect of the present disclosure. It shall be appreciated that the method 1200 of FIG. 23 can be implemented via the software stack 900 (FIG. 20) and any of the aforementioned processing devices implemented via the hardware architecture 800 (FIG. 19) or any other computing device communicably coupled to the robots 100, 200, 300 (FIGS. 1, 5, and 8). According to the non-limiting aspect of FIG. 23, the method 1200 can include receiving 1202 a signal from a sensing device 106, 206, 306 of the robot 100, 200, 300 (FIGS. 1, 5, and 8). The method 1200 can further include detecting 1204 a condition of the pipe based on the received signal. According to some non-limiting aspects, detecting 1204 the condition of the pipe can be algorithmically performed via an artificial intelligence model of the software stack 900 (FIG. 20) implemented by any of the aforementioned processing devices implemented via the hardware architecture 800 (FIG. 19) or any other computing device communicably coupled to the robots 100, 200, 300 (FIGS. 1, 5, and 8). For example, one algorithmic implementation of the detecting 1204 step is described in further detail with reference to FIG. 24.

In further reference to FIG. 23, the method 1200 can further include generating 1206 a situational alert based on the detected condition and transmitting 1208 the situational alert to an end user of the robot. For example, the detected condition can include at least one of an indication of structural damage to the pipe, an abnormal environment parameter, or an unpassable condition, or combinations thereof. The abnormal environment parameter can include at least one of a temperature, a pressure, or a hazardous gas, or combinations thereof. The unpassable condition can include at least one of a drop or a gap. According to non-limiting aspects wherein the robots 100, 200, 300 (FIGS. 1, 5, and 8) include an encoder, the method 1200 can further include receiving a signal from the encoder and generating a linear position estimate associated with the robot based on the signal received from the encoder. According to non-limiting aspects wherein the robots 100, 200, 300 (FIGS. 1, 5, and 8) include an IMU and a visual odometry system, the method 1200 can further include receiving a signal from the IMU, receiving a signal from the visual odometry system, and generating a fused linear position estimate associated with the robot based on the signal received from the encoder, the signal received from the IMU, and the signal received from the visual odometry system, wherein the fused linear position estimate is more accurate than the linear position estimate. It shall be appreciated that, the fused linear position estimate can be generated via a sensor fusion algorithm of the software stack 900 (FIG. 20), which can employ a mathematical technique that combines data from multiple sensors of the robots 100, 200, 300 (FIGS. 1, 5, and 8) to provide a more accurate and reliable estimate of the state of a system or environment.

Referring now to FIG. 24, an flow diagram of an algorithmic method of detecting 1204 the condition of the pipe performed via an artificial intelligence model is depicted in accordance with at least one non-limiting aspect of the present disclosure. According to the non-limiting aspect of FIG. 24, the detecting 1204 can include training 1210 the artificial intelligence model with training data comprising information associated with the pipe. Once the model is trained, the method can further include receiving 1212 a signal from a sensing device of a robot 100, 200, 300 (FIGS. 1, 5, and 8) deployed within the pipe and transmitting 1214 information associated with the received signal to the artificial intelligence model. The artificial intelligence model can then generate 1216 an output based on the information associated with the received signal, wherein the generated output comprises a determined condition of the pipe. The method can further include generating 1218 a situational alert based on the generated output and transmitting 1220 the situational alert to an end user of the robot deployed within the pipe.

Various non-limiting aspects illustrating implementation details of the robots 100, 200, 300 (FIGS. 1, 5, and 8), accessories 400, 500, 600, 700 (FIGS. 11A, 12A, 13, and 16), which can implement the hardware architecture 800 (FIG. 19) and software stack 900 (FIG. 20) as part of a system 1000 (FIG. 21) will now be explained in further detail. As depicted in FIG. 21, the improved pipeline inspection system 1000 can include four separate subsystems that work in concert. FIG. 21 illustrates these four components (Inspection Device, Tether Management Device, Deployment Garage, and Human Interface) as a block diagram. The function of each of these components is described below.

Inspection Device. An aspect of the inspection device, or robot 100, is illustrated in FIG. 1. For example, FIG. 1 provides an isometric view of the robot 100 that highlights a machine block housing design with four wheels as primary movers and two cameras (front and back) as primary sensing devices 106. Although not explicitly shown in the figure, the wheels 104 and the cameras are modular and can be swapped out using quick and hot swappable connectors. For mobility, this means that the wheels can be swapped out in the field such that the wheel diameter of the robot 100 can be optimally sized for the specifics of each pipeline, such as the shape, material, and current conditions within the pipe. The wheels can be equipped with prefabricated weights that provide additional traction to the robot 100.

These prefabricated weights and the modular wheel design that houses them are shown in FIG. 2. Alternative aspects of the improved pipeline inspection system include six wheeled, tracked, and a combination of track and wheel devices that have specialized inspection applications. For the aspect shown in FIG. 2, the four-wheel housing is independently driven, meaning that the platform has full skid steer capability. Furthermore, it can be configured for track or combinations of wheel and track mobility through the self-awareness module that recognizes the mobility configuration and optimizes the device control to leverage the capabilities of the prime mover configuration.

For cameras this means that cracked and broken lenses (which is the most common form of damage this device will experience) can be quickly and efficiently changed out in the field. In addition, these swap outs are not limited to exchange with the same device. Rather, the quick swappable connection can support a wide variety of sensors and combinations of sensors including LiDAR, Structured Light, microphones, SONAR, RADAR, and environmental sensor suites.

FIGS. 4A and 4B represents a frontal view of the robot 100, where the four bolts that affix the modular sensor mount to the inspection device are clearly shown. This module can be swapped out in the field with only an Allen wrench. It does not require any electrical work in the field, such as adding connectors or soldering. Furthermore, the self-awareness module of the system will recognize the addition of any new, and possibly different, sensing device and configure the inspection device to collect data appropriately. This is all done without any interaction from the user (except for the sensor swap out).

The inspection device includes several other capabilities that can be inferred from the line drawing. For example, the system 1000 of FIG. 21 illustrates the deployment and emergency retrieval loop. This loop is used to deploy the system when not using the optional deployment garage. In addition, the loop serves as an anchor point for emergency retrieval should the robot become disabled, and the tether fails during the primary mode of emergency retrieval. Other aspects of the inspection device that can be gleaned from direct observation of the line drawings are the various covers and pressure ports, which are external views of the sealing and pressurization of the internals of the device, including the batteries, power management, micro-controller, computer, GPU, VPU, as well as some of the interoceptive sensors such as the GNSS system.

Inspection Device Positioning. As mentioned, the inspection device includes advanced pipe odometry that is a fusion of multiple sources of physical and image-derived position data. In addition to that organic capability to collect engineering grade pipeline data (˜1 cm), the device has some optional features that improve the accuracy of the pipeline positioning to survey grade (˜1 mm). For current pipeline odometrical systems, the cable counter (on its best days) provides error profiles that manifest at about 1% of distance travel. This means that for an inspection on 100 feet of pipeline segment by current systems, the uncertainty in the position measurement at the endpoint is at best 1 foot, or 1% of 100 feet. In practice, the actual number is more like 2-5%, due to improper tether controls employed by the distracted operator. Although such current systems are suitable for general condition assessment, they are completely inappropriate for engineering or survey grade assessment.

For the improved pipeline inspection system, in addition to its internal odometry comprised of an advanced GNSS/INS systems support by four independent wheel odometers and visual odometry, the inspection device is capable of hosting support devices that dramatically improve the positioning accuracy of the collected data. These optional position support devices come in two fundamental forms: (1) a pull behind cart, and (2) a precision sidecar odometry wheel and revolutionary error-free smart cable that eliminates cable counter and odometry errors that plague current remote inspection systems. In both cases, the passive nature of the wheels (meaning they aren't powered and therefore don't realize much slip) improve the accuracy of the system.

It is important to remember that the inspection device can be used with various aspects of the improved pipeline inspection system, including performing general inspection without them. However, for ultra-precise positioning it is possible to use multiple side cars and the pull-behind cart to maximize the accuracy for survey grade inspection operations, e.g., like lateral location, dig and replace, or general geolocation.

Precise Positioning Cart. The inspection device has state-of-the-art odometry system derived from four independent wheel encoders, internal IMU, and visual odometry to produce a best-in-class fused linear position estimate. While this estimate easily meets the requirements for a PACP inspection (usually defined to be less than or equal to 1% error as a function of linear distance), it does not provide survey grade linear position estimates, nor does it provide 3D pose information. The precise positioning cart 220, shown in FIG. 5, provides additional accuracy to the linear position estimates and provides 3D pipeline position information that is suitable for precise engineering rehabilitation analysis and survey grade localization.

As shown in both FIGS. 5 and 6, the precise positioning cart (PPC) 220 is joined to the platform via the emergency retrieval ring. The PPC is a passive mobility device (meaning the inspection device drags it along as the inspection is underway). This passive mobility is important as the differential odometry on the PPC will suffer much less wheel slip (since the wheels are free spinning) and consequentially provide a much more accurate odometry estimate. This odometry estimate can be fused with the IMU on board the robot and will improve the linear position estimates significantly. Furthermore, it can be used to detect wheel slippage on the robot, which has other benefits beyond positioning, including advanced proprioceptive sensing and other features of the self-awareness and pipeline awareness modules.

Accurate linear positioning is the minimum requirement for PACP inspection; however, it is wildly insufficient for many rehabilitation projects and doesn't provide sufficient information to perform an accurate plan view locational (2D) or full 3D pipe geolocation. In the case, where 3D information is provided, the PPC provides a low-cost, accurate means to perform 3D pipe locations. This capability is provided by an advanced INS and odometry system that creates a fused position estimate in 3D. When coupled with the GPS locations of the invert of the upstream and downstream manholes (most commonly), this can provide an advanced survey grade geolocation of the entire extent of the pipeline, including precision location of the manhole as part of the inspection service. In other aspects, the precise positioning cart can be configured with additional sensors, including a SONDE for the location of shallow pipe using traditional means, radar, sonar, or other non-destructive sensors or testing apparatus.

Positioning Side Car. In cases where it isn't possible to deploy the precise positioning cart due to pipe conditions, (for example to much accumulated sediment), there exists another optional positioning device. Like the precise positioning cart, it is passive so it provides superior linear odometry from a passive wheel that is pressed into the pipe invert with a passive tensioning mechanism. Various aspects of the positioning side car 318 is shown in FIG. 8 In this figure, the odometry wheel is shown on a linear slide that is pressed into the invert of the pipe via a passive tensioning mechanism provided by the two flexible whiskers (shown more prominently in FIG. 10) that provide the necessary force to keep the wheel securely pressed to pipe invert. The slide is likewise passive so that debris or obstruction doesn't overly bind the platform during motion. If the platform encounters debris, the passive slide enables the wheel to be pressed up towards the pipe crown, increasing the effective ground clearance for the device and improving mobility dramatically over a fixed linear position.

As one might infer from the figure, it is possible to use a single positioning side car (as shown in FIG. 8) or a dual side car configuration (not shown). In addition, and as previously mentioned, the precision positioning cart can also be used with the various combinations of no, single, or dual side car deployment. This gives the ability for the user to increase the accuracy of the spatial indexing of inspection data to satisfy the requirements for general condition assessment, engineering grade assessment, or survey-grade localization with simple, easy to interface supplemental positioning systems.

Deployment Garage. The deployment garage is a part of the improved pipeline inspection system, but can also be thought of as a supplemental or optional component depending on the specifics of the inspection operations. This device, shown in FIGS. 13-18, provides several important benefits to both the operator, the inspection device, and the overall inspection operation.

The deployment garage is a multifunctional support device that is provided to increase the safety and efficiency of inspection operations, as well as to protect the inspection device during the deployment. As one might infer from the inspection device pictures in Appendix A, lowering the inspection device in a manhole directly from the retrieval hook means that the camera on the front of the device is at high risk for impact with the pipe invert during insertion. Cracked lenses, broken cameras, and waterlogged robots are the hallmark of this type of deployment gone wrong. FIGS. 13-18 provides an illustration of how the deployment garage protects the robot and the highly vulnerable camera lenses during the deployment operation.

The deployment garage isn't simply a mechanical device. It is an AI-powered intelligent device in the same manner as the inspection device and provides several additional support functions that are very useful in certain types of inspection operations. These support functions are described below.

Communication Relay. This provides a spread spectrum, mostly line of sight communication, through radio that is positioned within the deployment housing in such manner that it can transmit and receive communications from the inspection device during its operation. This communication coverage can come from a single deployment garage (at the point of deployment), or two deployment garages (one at the ingress point, one at the egress) to cover longer pipe runs where direct communication from a single access point is difficult.

Active Pipe Odometry. This innovation allows for the improved pipeline inspection system to spatially index data acquired within the pipeline to the level of accuracy that is required for engineering and survey grade operations. This active odometry, or wireless tether, is realized by the transmission and reception of ultra-sonic information from the transmitter in the deployment garage to the receiver in the inspection device. In this case, the distance down the pipe can be inferred from time-of-flight calculations if the garage and inspection devices are properly time synchronized. In other configurations, the deployment garage and the device both have transmit and receive capabilities and can compute distances based on time-of-flight. This is done without a requirement for any time synchronization on the inspection and deployment garage devices. In other aspects, multiple deployment garages can be used to provide upstream and downstream (dual channel) communications and signaling for longer or more geometrically challenging inspection operations. In other aspects, the transmitted signals can be emitted radio frequency waves, photons, or other types of signals suitable for time-of-flight distance calculations.

Multi-Segment Inspection Support. The deployment garage supports multi-segment inspection, empowering the operator to swap the tether quickly and efficiently at the egress manhole. In various aspects, this swap is done manually by the operator. In other aspects, this is done automatically by the deployment garage itself. The multi-segment hopping dramatically improves efficiency of the operator and minimizes site impact by allowing the operator to “leap-frog” deployment garages, switch out the tether, and to continue to inspect without requiring the operator to extract the robot back to the ingress point and then manually move it down to the next ingress point.

Tether-less Operation. While the deployment garage isn't required for manual operation of the device, it may be utilized for tether-less operation. The deployment garage can include an electronic communication relay which can act as the primary means of communication between the inspection device and the human interface at either the ingress or egress manhole (or both). In aspects where the inspection device is autonomous, the deployment garage can be also viewed as optional.

Tether Modules. The improved pipeline inspection system may include one of two different tether modules that provide similar levels of functionality and deployment. In both cases, the tether module is configured to provide reliable communications between the inspection device and the human machine interface. According to various aspects, the medium of communications is Ethernet over fiber. Of course, according to other aspects, other mediums can be utilized.

Standard Tether Module. According to various aspects, a first tether module is a bucket tether, as shown in FIGS. 11A and 11B. In the figure, the bucket shape represents the external housing that covers the tether, tether reel, slip wring, electronics—including computer, radio and associated transceivers, batteries, and shore power. The tether device includes the addition of optional motor and motor controller that can automate some tether functions like inspection device retrieval, tether management and tensioning, and provide support for multi-segment hopping and tether quick swap capabilities. In various aspects, the physical medium for the tether is optical fiber, but any combination of copper (power and/or comms) and fiber (high speed communications) is possible. According to various aspects, the transport layer is high speed ethernet over fiber or copper (including coax as an option).

The tether device may also include a standard hand crank, also visible in FIGS. 11A and 11B. The hand crank can be used to reel the tether back into the bucket as the means of primary system retrieval and cable management. The system can be upgraded with an optional motor as previously mentioned to enable automation of retrieval and reduce the physical exertion required of the operator. This motor can be configured in conjunction with motion of the robot to provide mobility assistance to the device during retrieval. Furthermore, as can be gleaned from the FIGS. 11A and 11B the device can be bolted down with standard connections to improve the ergonomics and site safety.

FIG. 11B shows the tether device in profile view. In this view, the tether and quick connection are shown extending from the mouth of the tether spool. This rugged, low-cost deployment support is provided with the inspection device with the system being capable of supporting up to 500 linear feet of shielded and strengthened cable housing either an optical or electrical communications supports.

Industrial Tether Module. According to various aspects, a second tether module is an advanced deployment system that includes all the features of the first tether module as well as some critical upgrades, including reliability, improved cable management, improved performance, and site safety, as well as critical additional support features for customers with more demanding use requirements. Examples of these types of customers would be contractors or larger municipalities that demand a higher level of performance and can afford a higher price point.

Absolute Linear Distance Measurement Module. Cable counters, integrated wheel odometry, and supplemental positioning devices all help and can improve the accuracy of the distance measurements from 1 meter level to a few centimeters that is good enough for most automated engineering analytics, e.g., like accurately measuring the distance between pipe joints. However, this isn't sufficient for pipeline survey and geolocation activities which need data to be provided with sub centimeter accuracy.

FIGS. 12A-C highlights an aspect of the improved pipeline inspection system that provides mm level distance measuring over arbitrary lengths of tether. This solution is revolutionary in that it eliminates drift by placing an absolute position marker on the tether that is fused to a specific location on the tether. These markers are implemented by passive RF ID tags (fused to the tether) on standard intervals, such as, for example, 1 meter, 2 meters, or 5 meters. The unique ID of each RF tag is associated with its absolute fused position on the cable. This means that every time the segment of the tether with an RFID tag pass through the receiver ring, all the cumulative error is zeroed out at that point.

When used in conjunction with combinations of cable counter, individual and fused wheel odometry, visual odometry, and other relative positioning methods and the positioning components of the pipeline awareness AI-core, this capability provides the user the ability to locate in absolute, 3D reference frames the complete set of features and defects within the pipeline at the millimeter level. Further it provides advanced operational modes that aren't possible in other systems. Such advanced operational modes are described below.

Independent and Precision Pipe Joint and Pipe Stick Inspection. In contrast to the improved pipeline inspection system, independent and precision joint and pipe stick inspection isn't possible in current condition assessment systems due to the cumulative cable measurement error that corrupts any measurement of pipe segment length and makes it impossible to segment pipeline joint data from pipeline segment data. The segmentation of joint data from pipeline segment data is important for remaining useful life analysis as most joints are designed to have offsets or recesses that form part of the normal function of the pipeline. These can be mistaken for defects, particularly when using non-video data like LiDAR or Sonar. The accurate detection of pipeline joints by the improved pipeline inspection system enables new types of reports that include pipe stick reports. These reports identify the pipe sticks that comprise the pipeline segment through joint identification techniques and break the pipeline segment down into its constituent sticks. For example, a 200 linear foot segment of 12″ VCP pipeline may be comprised of ten 20 foot VCP pipe sticks. These sticks are assembled underground (usually through a bell and spigot joint) into the 200-foot segments during installation. Pipe stick reports break the pipeline segment into individual sticks and separate the joint data from the pipeline data. This improves the accuracy of all analytics and provides additional insight into the pipeline condition.

Human Machine Interface. It will be appreciated that the operation of the improved pipeline inspection system includes an interaction between a human operator and the integrated robot system. This interface allows an operator to view the real-time images/videos captured by the inspection device, control the motion of the inspection device as well as the LED lighting for all cameras individually, retrieve inspection device status, set odometry starting point, input PACP inspection header information, initiate/stop inspections, and execute other related actions. The interface software operates to create an inspection data package with recorded videos, PACP header, and other related inspection data such as odometry, and upload inspection data package to the “Pipe Dream” cloud for future process without human intervention. The interface software maintains the local database in the inspection device and allows the operator to select which inspection date package(s) they would like to upload. This makes it possible to transfer the required large data packages only and reduce the usage of energy.

Working with the sensors and native AI engines equipped in the inspection device, the interface software also provides situational alerts to the operator. The alerts include but are not limited to severe structure damage, abnormal environment parameters (temperature, pressure, toxic/explosive gases, etc.), unpassable conditions (drops, gaps, etc.), and so on.

Working with the effectors, actuator, and motors equipped in the inspection device, the interface also allows the operator to execute maintenance operations in the pipe.

The human machine interface allows users to log in to the system and view the live image/videos and system status remotely. This opens various possibilities such as remote diagnostics and evaluation by expert without the high business travel cost.

Along with other components in the system, the software supports location and usage history logging for asset management purpose.

Utilizing the powerful AI engines in the inspection device, the system can process the captured sensor data, including but not limited to image/video, locally on the inspection device and create evaluation summary including PACP coding and reports. This edge computation and processing capability eliminates the need of moving huge amounts of data around which makes the system more efficient and ecofriendly.

Environmental Impact Analysis. When comparing the improved pipeline inspection system to traditional inspection systems/services, such as pre-equipped CCTV vans or trucks, it is obvious that the improved pipeline inspection system will significantly reduce the environmental impact of each workday. Drawing average carbon emission data information from standard box truck models, a CCTV sprinter van will emit an average of 89 pounds of carbon dioxide per day, a CCTV truck will emit 207 pounds, and the improved pipeline inspection system will emit only 40 pounds. This is comparable to a daily consumption of 4.5 gallons, 10.5 gallons, and 2 gallons of gasoline respectively. Please note that the improved pipeline inspection system doesn't directly emit C02, nor does it consume fuel. However, the process of charging the batteries requires electricity and the process of electricity generation can create emissions depending on the fuel source used in that generation.

These numbers also account for average travel times to and from sites, as well as running the inspection system. A large factor in the comparatively low emission rate of the improved pipeline inspection system is that most truck/van inspections have to both idle the vehicle and run a generator for the duration of each inspection, which requires an average of 4.5 to 6 gallons of gasoline per day. The improved pipeline inspection system does not require a generator to operate (it is battery powered) and is a large reason why the improved pipeline inspection system is much safer on the environment. Any carbon emissions from the improved pipeline inspection system, other than driving to and from the job site, comes from charging the battery, which must be done only once per day of inspection, and emits energy equivalent to burning just ⅛ of a gallon of gasoline.

Since the improved pipeline inspection system is not directly connected to these larger truck/van-based systems, and the system can be easily deployed from any type of vehicle, the above calculations for the system were done using data from the most widely owned sedans (production costs are not included or factored into the numbers).

Disposability Analysis. The improved pipeline inspection system is designed to be robust to supply chain issues as it uses almost exclusively commodity components that can be sourced from multiple vendors. In addition, it features a ultra-low cost bill-of-materials (BOM) that roughly establishes an equivalency in terms of a repair versus replacement equation. This alleviates the need for customers to perform any maintenance on the core elements of the system.

Site Impact Analysis. Site analysis impact is relatively straight forward with the improved pipeline inspection system. The system is hand or backpack portable, weighs less than 10 pounds, with a design so compact that a small pelican case can contain the robot, the tether, the controller, and an interfacing laptop/tablet. The system can be carried on a plane or mailed through standard or express mail with ease. In addition to its carbon neutrality (as previously discussed), the system doesn't require generators or support trucks, is completely battery operated, and is ergonomically designed (with support from deployment garage) to be deployed into the most complex manhole structures with ease.

Although the various aspects of the improved pipeline inspection system have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles. For example, although the invention was described in the context of its use with sewer pipes, the general principles of the invention are equally applicable to the inspection of other types of pipelines (e.g., water pipes).

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Examples of the method according to various aspects of the present disclosure are provided below in the following numbered clauses. An aspect of the method may include any one or more than one, and any combination of, the numbered clauses described below.

Clause 1. A robot configured for inspection of a pipe, the robot including a housing, a sensing device coupled to the housing, a plurality of wheels rotatably coupled to the housing, a carbon-neutral power source positioned within the housing, and a computing device communicably coupled to the sensing device and the carbon-neutral power source, wherein the computing device includes a processing unit and a memory to store a software stack that, when executed by the processing unit, causes the computing device to receive a signal from the sensing device, detect a condition of the pipe based on the received signal, generate a situational alert based on the detected condition, and transmit the situational alert to an end user of the robot.

Clause 2. The robot according to clause 1, wherein the detected condition includes at least one of an indication of structural damage, an abnormal environment parameter, or an unpassable condition, or combinations thereof.

Clause 3. The robot according to either of clauses 1 or 2, wherein the abnormal environment parameter includes at least one of a temperature, a pressure, or a hazardous gas, or combinations thereof.

Clause 4. The robot according to any of clauses 1-3, wherein the unpassable condition includes at least one of a drop or a gap.

Clause 5. The robot according to any of clauses 1-4, further including an encoder and wherein, when executed by the processing unit, the software stack is further configured to cause the computing device to receive a signal from the encoder, and generate a linear position estimate associated with the robot based on the signal received from the encoder.

Clause 6. The robot according to any of clauses 1-5, wherein the generated linear position estimate complies with a requirement imposed by the Pipeline Assessment Certification Program.

Clause 7. The robot according to any of clauses 1-6, wherein the generated linear position estimate is survey-grade.

Clause 8. The robot according to any of clauses 1-7, further including an inertial measurement unit (“IMU”) and a visual odometry system, and wherein, when executed by the processing unit, the software stack is further configured to cause the computing device to receive a signal from the IMU, receive a signal from the visual odometry system, and generate a fused linear position estimate associated with the robot based on the signal received from the encoder, the signal received from the IMU, and the signal received from the visual odometry system, wherein the fused linear position estimate is more accurate than the linear position estimate.

Clause 9. The robot according to any of clauses 1-8, further including a sidecar configured for selective engagement with the robot, wherein the IMU, and the visual odometry system are position within the sidecar.

Clause 10. The robot according to any of clauses 1-9, wherein the encoder, further including a precise positioning system configured for selective engagement with the robot, wherein the IMU, and the visual odometry system are position within the precise positioning system.

Clause 11. The robot according to any of clauses 1-10, further including a retrieval ring configured for selective engagement with a tether.

Clause 12. The robot according to any of clauses 1-11, wherein the tether is configured for transmission of power and communications to and from the robot.

Clause 13. The robot according to any of clauses 1-12, wherein the tether includes a plurality of markers fused at predetermined intervals, wherein an absolute position of the robot can be calculated based on a marker of the plurality of markers passing through an active scanner positioned on a housing of the tether.

Clause 14. The robot according to any of clauses 1-13, wherein each wheel of the plurality of wheels is modular and interchangeably attachable to the housing via a quick connect connector.

Clause 15. The robot according to any of clauses 1-14, wherein the sensing device is one of a plurality of sensing devices configured to be interchangeably attachable to the housing via an electro-mechanical connection.

Clause 16. A system for inspecting a pipe, the system including a tether including a housing and an interior reel of line, a deployment garage including a frame and a carriage, wherein the frame can be selectively coupled to the line of the tether, and a robot configured to be positioned within the carriage of the deployment garage, wherein the robot includes a plurality of wheels, a housing that can be selectively coupled to the line of the tether, a carbon-neutral power source positioned within the housing, a sensing device configured for selective engagement to the housing, and a computing device communicably coupled to the sensing device and the carbon-neutral power source, wherein the computing device includes a processing unit and a memory to store a software stack that, when executed by the processing unit, causes the computing device to receive a signal from the sensing device, detect a condition of the pipe based on the received signal, generate a situational alert based on the detected condition, and transmit the situational alert to an end user of the robot.

Clause 17. The system according to clause 15, wherein the robot further includes an encoder and wherein, when executed by the processing unit, the software stack is further configured to cause the computing device to receive a signal from the encoder, and generate a linear position estimate associated with the robot based on the signal received from the encoder.

Clause 18. The system according to either of clauses 16 or 17, wherein the robot further includes an inertial measurement unit (“IMU”) and a visual odometry system, and wherein, when executed by the processing unit, the software stack is further configured to cause the computing device to receive a signal from the IMU, receive a signal from the visual odometry system, and generate a fused linear position estimate associated with the robot based on the signal received from the encoder, the signal received from the IMU, and the signal received from the visual odometry system, wherein the fused linear position estimate is more accurate than the linear position estimate.

Clause 19. The system according to any of clauses 16-18, wherein each wheel of the plurality of wheels is modular and interchangeably attachable to the housing via a mechanical connector, and wherein the sensing device is one of a plurality of sensing devices configured to be interchangeably attachable to the housing via an electro-mechanical connection.

Clause 20. A computer-implemented method of inspecting a pipe, the method including training an artificial intelligence model with training data including information associated with the pipe, receiving, via the processor, a signal from a sensing device of a robot deployed within the pipe, transmitting, via the processor, information associated with the received signal to the artificial intelligence model, generating, via the artificial intelligence model, an output based on the information associated with the received signal, wherein the generated output includes a determined condition of the pipe, generating, via the processor, a situational alert based on the generated output, and transmitting, via the processor, the situational alert to an end user of the robot deployed within the pipe.

Although the various aspects of the fall protection apparatus, system and method have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles. For example, although the invention was described in the context of its use with aerial lifts and other boom/basket lifting devices, the general principles of the invention are equally applicable to other types of workplace environments (e.g., in an environment where a ladder is being used).

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A robot configured for inspection of a pipe, the robot comprising:
a housing;
a sensing device coupled to the housing;
a plurality of wheels rotatably coupled to the housing;
a carbon-neutral power source positioned within the housing; and
a computing device communicably coupled to the sensing device and the carbon-neutral power source, wherein the computing device comprises a processing unit and a memory to store a software stack that, when executed by the processing unit, causes the computing device to:
receive a signal from the sensing device;
detect a condition of the pipe based on the received signal;
generate a situational alert based on the detected condition; and
transmit the situational alert to an end user of the robot.

2. The robot of claim 1, wherein the detected condition comprises at least one of an indication of structural damage, an abnormal environment parameter, or an unpassable condition, or combinations thereof.

3. The robot of claim 2, wherein the abnormal environment parameter comprises at least one of a temperature, a pressure, or a hazardous gas, or combinations thereof.

4. The robot of claim 2, wherein the unpassable condition comprises at least one of a drop or a gap.

5. The robot of claim 1, further comprising an encoder and wherein, when executed by the processing unit, the software stack is further configured to cause the computing device to:
receive a signal from the encoder; and
generate a linear position estimate associated with the robot based on the signal received from the encoder.

6. The robot of claim 5, wherein the generated linear position estimate complies with a requirement imposed by the Pipeline Assessment Certification Program.

7. The robot of claim 5, wherein the generated linear position estimate is survey-grade.

8. The robot of claim 5, further comprising an inertial measurement unit (“IMU”) and a visual odometry system, and wherein, when executed by the processing unit, the software stack is further configured to cause the computing device to:
receive a signal from the IMU;
receive a signal from the visual odometry system; and
generate a fused linear position estimate associated with the robot based on the signal received from the encoder, the signal received from the IMU, and the signal received from the visual odometry system, wherein the fused linear position estimate is more accurate than the linear position estimate.

9. The robot of claim 8, wherein the encoder, further comprising a sidecar configured for selective engagement with the robot, wherein the IMU, and the visual odometry system are position within the sidecar.

10. The robot of claim 8, wherein the encoder, further comprising a precise positioning system configured for selective engagement with the robot, wherein the IMU, and the visual odometry system are position within the precise positioning system.

11. The robot of claim 1, further comprising a retrieval ring configured for selective engagement with a tether.

12. The robot of claim 11, wherein the tether is configured for transmission of power and communications to and from the robot.

13. The robot of claim 11, wherein the tether comprises a plurality of markers fused at predetermined intervals, wherein an absolute position of the robot can be calculated based on a marker of the plurality of markers passing through an active scanner positioned on a housing of the tether.

14. The robot of claim 1, wherein each wheel of the plurality of wheels is modular and interchangeably attachable to the housing via a quick connect connector.

15. The robot of claim 11, wherein the sensing device is one of a plurality of sensing devices configured to be interchangeably attachable to the housing via an electro-mechanical connection.

16. A system for inspecting a pipe, the system comprising:
a tether comprising a housing and an interior reel of line;
a deployment garage comprising a frame and a carriage, wherein the frame can be selectively coupled to the line of the tether; and
a robot configured to be positioned within the carriage of the deployment garage, wherein the robot comprises:
a plurality of wheels;
a housing that can be selectively coupled to the line of the tether;
a carbon-neutral power source positioned within the housing;
a sensing device configured for selective engagement to the housing; and
a computing device communicably coupled to the sensing device and the carbon-neutral power source, wherein the computing device comprises a processing unit and a memory to store a software stack that, when executed by the processing unit, causes the computing device to:
receive a signal from the sensing device;
detect a condition of the pipe based on the received signal;
generate a situational alert based on the detected condition; and
transmit the situational alert to an end user of the robot.

17. The system of claim 16, wherein the robot further comprises an encoder and wherein, when executed by the processing unit, the software stack is further configured to cause the computing device to:
receive a signal from the encoder; and
generate a linear position estimate associated with the robot based on the signal received from the encoder.

18. The system of claim 17, wherein the robot further comprises an inertial measurement unit (“IMU”) and a visual odometry system, and wherein, when executed by the processing unit, the software stack is further configured to cause the computing device to:
receive a signal from the IMU;
receive a signal from the visual odometry system; and
generate a fused linear position estimate associated with the robot based on the signal received from the encoder, the signal received from the IMU, and the signal received from the visual odometry system, wherein the fused linear position estimate is more accurate than the linear position estimate.

19. The system of claim 16, wherein each wheel of the plurality of wheels is modular and interchangeably attachable to the housing via a mechanical connector, and wherein the sensing device is one of a plurality of sensing devices configured to be interchangeably attachable to the housing via an electro-mechanical connection.

20. A computer-implemented method of inspecting a pipe, the method comprising:
training an artificial intelligence model with training data comprising information associated with the pipe;
receiving, via the processor, a signal from a sensing device of a robot deployed within the pipe;
transmitting, via the processor, information associated with the received signal to the artificial intelligence model;
generating, via the artificial intelligence model, an output based on the information associated with the received signal, wherein the generated output comprises a determined condition of the pipe;
generating, via the processor, a situational alert based on the generated output; and
transmitting, via the processor, the situational alert to an end user of the robot deployed within the pipe.
